(19) United States
(12) Patent Application Publication
(10) Pub. No.: US 2013/0199572 A1
(43) Pub. Date: Aug. 8, 2013

(54) FILM-FORMING APPARATUS, AND METHOD FOR MAINTAINING FILM-FORMING APPARATUS

(71) Applicants: Takuro Hayashi, Chigasaki-shi (JP); Kouji Sogabe, Chigasaki-shi (JP); Koichi Matsumoto, Chigasaki-shi (JP); Masanori Hashimoto, Sammu-shi (JP); Kyuzo Nakamura, Chigasaki-shi (JP); Munemoto Hagiwara, Chigasaki-shi (JP); Hiroto Uchida, Chigasaki-shi (JP); Katsuhiko Mori, Chigasaki-shi (JP); Yasuo Shimizu, Chigasaki-shi (JP); Moriaki Sakamoto, Chigasaki-shi (JP)

(72) Inventors: Takuro Hayashi, Chigasaki-shi (JP); Kouji Sogabe, Chigasaki-shi (JP); Koichi Matsumoto, Chigasaki-shi (JP); Masanori Hashimoto, Sammu-shi (JP); Kyuzo Nakamura, Chigasaki-shi (JP); Munemoto Hagiwara, Chigasaki-shi (JP); Hiroto Uchida, Chigasaki-shi (JP); Katsuhiko Mori, Chigasaki-shi (JP); Yasuo Shimizu, Chigasaki-shi (JP); Moriaki Sakamoto, Chigasaki-shi (JP)

(73) Assignee: ULVAC, INC., Chigasaki-shi (JP)

(21) Appl. No.: 13/805,929

(22) PCT Filed: Jun. 22, 2011
(86) PCT No.: PCT/JP2011/064288

§ 371 Date: Apr. 3, 2013

(30) Foreign Application Priority Data
Jun. 25, 2010 (JP) 2010-145350

(51) Int. Cl. B08B 7/00

(52) U.S. Cl. CPC B08B 7/00
USPC 134/19; 118/712

(57) ABSTRACT

Ignition sections are provided at two locations on each of lower portions of the side surfaces on both sides of a film-forming chamber so as to be provided at four locations in total. A flowing current is applied to the ignition sections when a flammable by-product is ignited. A first detecting section for measuring a pressure in the film-forming chamber is formed on the side surface of the film-forming chamber. A second detecting section is formed at the lower portion of the side surface of the film-forming chamber. A third detecting section for measuring a spatial temperature in the film-forming chamber is formed at an upper portion of the film-forming chamber.

### TECHNICAL FIELD

The present invention relates to a film-forming apparatus that forms a film on a substrate, and a method for maintaining the film-forming apparatus.

Priority is claimed on Japanese Patent Application No. 2010-145350, filed Jun. 25, 2010, the content of which is incorporated herein by reference.

### BACKGROUND ART

In the present solar cells, a monocrystalline silicon (Si) type and a polycrystalline silicon type occupy most of the solar cells. However, there are growing concerns about a material shortage of Si, or the like. In recent years, the demand for thin-film solar cells in which a thin film Si layer with a low manufacturing cost and a low risk of the material shortage is formed is increasing. Moreover, in addition to thin-film solar cells with only an a-Si (amorphous silicon) layer of a conventional type, recently, the demand for tandem-type thin-film solar cells in which the a-Si layer and a μc-Si (microcrystalline silicon) layer are laminated in order to improve conversion efficiency is increasing.

Plasma-CVD apparatuses are often used for film forming of the thin film silicon layer (semiconductor layer) of the thin-film solar cells. A single wafer processing PE-CVD (plasma-CVD) apparatus, an in-line type PE-CVD apparatus a batch processing PE-CVD apparatus, and the like are present as the plasma-CVD apparatuses.

However, a problem with the manufacture of the tandem-type thin-film solar cells is that handling of a large amount of polysilane powder that is a by-product formed simultaneously when the microcrystalline silicon (μm-Si) power generation layer is formed by using a CVD method.

Since the polysilane powder is dark brown powder (brown powder), and is flammable, this powder requires caution in handling.

If film forming of substrates is continuously performed in the film-forming chamber, the by-product adheres to various parts inside the film-forming chamber. If the by-product adheres onto the substrate during the subsequent film forming, problems occurs in that the conversion efficiency of the thin-film solar cells declines.

Conventionally, water (steam) is sprayed to the by-product before maintenance (cleaning) of the film-forming chamber for prevention of static electricity or prevention of scattering of the by-product (for example, refer to Patent Document 1).

However, in this method, since the by-product is turned into a liquid by water (steam) and has viscosity, the by-product is not easily removed. Additionally, since water is used, there is a problem such that start-up of the chamber after maintenance requires substantial time.

### RELATED ART DOCUMENT

### Patent Document

[Patent Document 1] Japanese Unexamined Patent Application, First Publication No. 2010-1554

### SUMMARY OF INVENTION

### Technical Problem

The invention has been made in view of the conventional circumstances as described above. A first object thereof is to provide a film-forming apparatus that can rapidly and simply process a by-product which contains polysilane formed when a silicon film is formed, while film forming is not performed.

Moreover, a second object of the invention is to provide a method for maintaining the film-forming apparatus that can rapidly and simply process the by-product which contains the polysilane formed when the silicon film is formed, while the film forming is not performed.

### Solution to Problem

In order to solve the above problems and to achieve the first and second objects, some aspects of the invention provide a film-forming apparatus and a method for maintaining the film-forming apparatus as follows.

(1) A film-forming apparatus according to an aspect of the invention includes: a film-forming chamber in which a film is formed on a substrate under reduced pressure; an ignition section that ignites a flammable by-product formed in the film-forming chamber; a first gas charging section that supplies an oxygen gas to the film-forming chamber; a second gas charging section that supplies a nitrogen gas to the film-forming chamber; and a first detecting section that measures a pressure in the film-forming chamber.

(2) In the film-forming apparatus described in the above (1), the film-forming chamber may be provided with a second detecting section that measures a temperature of the by-product.

(3) In the film-forming apparatus described in the above (1) or (2), the film-forming chamber may be provided with a third temperature detecting section that measures a spatial temperature in the film-forming chamber.

(4) A method for maintaining a film-forming apparatus according to an aspect of the invention which is a method for maintaining a film-forming apparatus that forms a film on a substrate under reduced pressure includes: conveying the substrate having the film formed thereon from an inside of a film-forming chamber of the film-forming apparatus to an outside of the film-forming chamber (Process A); charging an oxygen gas into the film-forming chamber (Process B); igniting a flammable by-product formed by film forming (Process C); burning the by-product (Process D); charging a nitrogen gas into the film-forming chamber (Process E); and removing a non-flammable oxidized by-product formed when the by-product is burned from the film-forming chamber (Process F).

(5) In the method for maintaining the film-forming apparatus described in the above (4), in Process D, the oxygen gas may be supplied to the film-forming chamber in order to control a pressure in the film-forming chamber to be constant in substance.

(6) In the method for maintaining the film-forming apparatus described in the above (4) or (5), in Process D, an evacuation system of the film-forming chamber may be closed.

(7) In the method for maintaining the film-forming apparatus described in any one of the above (4) to (6), in Processes C and D, a pressure control may be performed in order to control a pressure in the film-forming chamber to be constant in substance.

(8) In the method for maintaining the film-forming apparatus described in any one of the above (4) to (6), in Process C, a pressure control may be performed in order to control a pressure in the film-forming chamber to be lower than that in the burning.

(9) In the method for maintaining the film-forming apparatus described in any one of the above (4) to (8), an evacuation gas evacuated from the film-forming chamber may be diluted with the nitrogen gas (Process G).

### Advantageous Effects of Invention

According to the film-forming apparatus related to the above aspect of the invention, the flammable by-product can be turned into non-flammable oxide by charging oxygen to the by-product inside the film-forming chamber and by burning the by-product. Accordingly, it is possible to rapidly and simply process the by-product which contains the polysilane formed when the silicon film is formed, while the film forming is not performed.

According to the method for maintaining the film-forming apparatus related to the above aspect of the invention, the flammable by-product can be turned into the non-flammable oxide by including igniting the by-product inside the film-forming chamber, charging oxygen to the by-product, and burning the by-product. Accordingly, it is possible to rapidly and simply process the by-product which contains the polysilane formed when the silicon film is formed, while the film forming is not performed.

### BRIEF DESCRIPTION OF DRAWINGS

FIG. 1 is a schematic cross-sectional view showing an example of a thin-film solar cell that is an example of a film-formed object.

FIG. 2 is a schematic configuration view of a film-forming apparatus in an embodiment of the invention.

FIG. 3A is a perspective view of a film-forming chamber in the embodiment.

FIG. 3B is the perspective view when the film-forming chamber in the embodiment is viewed from a different angle.

FIG. 3C is a side view of the film-forming chamber in the embodiment.

FIG. 3D is a cross-sectional view showing an example of an ignition sections in the embodiment.

FIG. 4A is a perspective view of an electrode unit in the embodiment.

FIG. 4B is a perspective view of the electrode unit in the embodiment from a different angle.

FIG. 4C is a partial exploded perspective view of the electrode unit in the embodiment.

FIG. 4D is a partial cross-sectional view of a cathode unit and an anode unit of the electrode unit in the embodiment.

FIG. 5A is a perspective view of a loading and unloading chamber in the embodiment.

FIG. 5B is a perspective view of the loading and unloading chamber in the embodiment from a different angle.

FIG. 6 is a schematic configuration view of a push-pull mechanism in the embodiment.

FIG. 7A is a perspective view showing a schematic configuration of a substrate attachment and detachment chamber in the embodiment.

FIG. 7B is a front view showing the schematic configuration of the substrate attachment and detachment chamber in the embodiment.

FIG. 8 is a perspective view of a substrate accommodating cassette in the embodiment.

FIG. 9 is a perspective view of a carrier in the embodiment.

FIG. 10 is an explanatory view (1) showing a film forming process of the film-forming apparatus related to the embodiment.

FIG. 11 is an explanatory view (2) showing the film forming process of the film-forming apparatus related to the embodiment.

FIG. 12 is an explanatory view (3) showing the film forming process of the film-forming apparatus related to the embodiment.

FIG. 13 is an explanatory view (4) showing the film forming process of the film-forming apparatus related to the embodiment.

FIG. 14 is an explanatory view (5) showing the film forming process of the film-forming apparatus related to the embodiment.

FIG. 15A is an explanatory view (1) showing the movement of the push-pull mechanism in the embodiment.

FIG. 15B is an explanatory view (2) showing the movement of the push-pull mechanism in the embodiment.

FIG. 16 is an explanatory view (6) showing the film forming process of the film-forming apparatus related to the embodiment.

FIG. 17 is an explanatory view (7) showing the film forming process of the film-forming apparatus related to the embodiment.

FIG. 18 is an explanatory view (8) showing the process of a method for manufacturing a thin-film solar cell related to the embodiment and is a schematic cross-sectional view when substrates are inserted into the electrode unit.

FIG. 19 is an explanatory view (9) showing the film forming process of the film-forming apparatus related to the embodiment.

FIG. 20 is an explanatory view (10) showing the film forming process of the film-forming apparatus related to the embodiment.

FIG. 21 is an explanatory view (11) showing the process of the method for manufacturing the thin-film solar cell related to the embodiment and is a partial cross-sectional view when substrates are set in the electrode unit.

FIG. 22 is an explanatory view (12) showing the film forming process related to the embodiment.

FIG. 23 is an explanatory view (13) showing the film forming process of the film-forming apparatus related to the embodiment.

FIG. 24 is an explanatory view (14) showing the film forming process of the film-forming apparatus related to the embodiment.

FIG. 25 is an explanatory view (15) showing the film forming process of the film-forming apparatus related to the embodiment.

FIG. 26 is a schematic configuration view showing another aspect of the film-forming apparatus related to the embodiment.

FIG. 27 is a schematic configuration view showing another arrangement method of the film-forming apparatus in the embodiment of the invention.

FIG. 28 is a schematic configuration view showing still another arrangement method of the film-forming apparatus in the embodiment of the invention.

FIG. 29 is an explanatory view showing Processes B, C, D, E-1, and E-2 of the method for maintaining the film-forming apparatus in the embodiment of the invention.

FIG. 30 is a graph showing changes in film-forming chamber pressure in the processes of the method for maintaining the film-forming apparatus related to the embodiment.

FIG. 31 is an explanatory view showing Processes B, C, D, E-1, and E-2 of a maintenance method related to another embodiment of the film-forming apparatus of the invention.

FIG. 32 is a graph showing changes in film-forming chamber pressure in the processes of the method for maintaining the film-forming apparatus related to the embodiment.

FIG. 33 is a graph showing one example of the invention.

### DESCRIPTION OF EMBODIMENTS

A film-forming apparatus and a method for maintaining the film-forming apparatus according to an embodiment of the invention will be described below.

(Thin-Film Solar Cell)

First, the structure of a thin-film solar cell that is an instance of a film-formed object by using a film-forming apparatus of the present embodiment is explained.

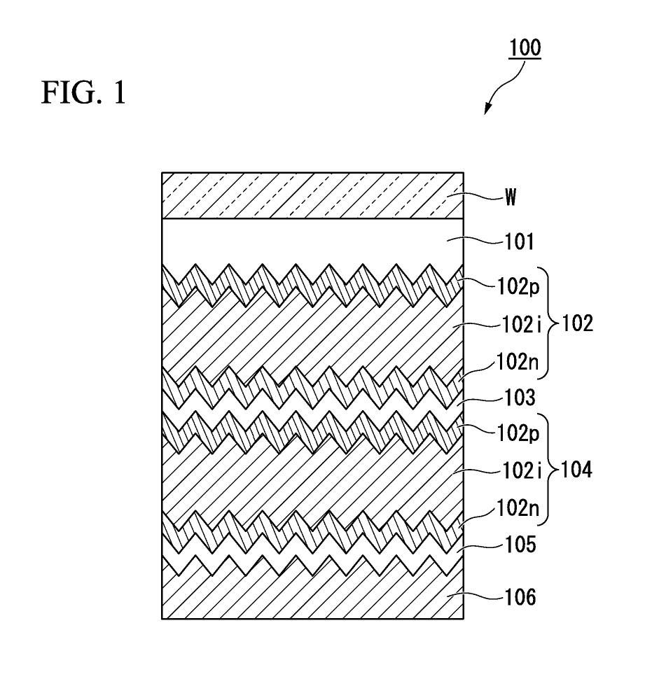

FIG. 1 is a cross-sectional view of the thin-film solar cell. As shown in FIG. 1, in the thin-film solar cell 100, a substrate W that constitutes a surface, an upper electrode 101 made of a transparent conductive film provided on the substrate W, a top cell 102 made of amorphous silicon, an intermediate electrode 103 made of a transparent conductive film provided between the top cell 102 and the bottom cell 104 as described below, a bottom cell 104 formed of microcrystalline silicon, a buffer layer 105 made of a transparent conductive film, and a back electrode 106 made of a metal film are laminated.

That is, the thin-film solar cell 100 is an a-Si/microcrystal Si tandem type solar cell. In the thin-film solar cell 100 of the tandem structure, power generation efficiency can be improved by absorbing short wavelength light in the top cell 102 and by absorbing long wavelength light in the bottom cell 104, respectively.

A three-layer structure of a p layer (102p), an i layer (102i), and an n layer (102n) of the top cell 102 is formed of amorphous silicon. Additionally, a three-layer structure of a p layer (104p), an i layer (104i), and an n layer (104n) of the bottom cell 104 is formed of microcrystalline silicon.

In the thin-film solar cell 100 configured as described above, if energetic particles called photons contained in sunlight enter the i layer, electrons and positive holes are generated by a photovoltaic effect, and the electrons move toward the n layer and the positive holes move toward the p layer. Light energy can be converted into the electrical energy by taking out the electrons generated by photovoltaic effect to the upper electrode 101 and the back electrode 106.

Moreover, since a part of the light that passes through the top cell 102 and reaches the bottom cell 104 is reflected by the intermediate electrode 103 and enters the top cell 102 again by providing the intermediate electrode 103 between the top cell 102 and the bottom cell 104, the sensitivity characteristics of the cell are improved, which contributes to improvements in power generation efficiency.

The sunlight that has entered from the glass substrate W (hereinafter simply referred to as substrate W) passes through the layers and is reflected by the back electrode 106. In order to improve the conversion efficiency of the light energy in the thin-film solar cell 100, a texture structure aiming at the prismatic effect such as extending the optical path of the sunlight that has entered the upper electrode 101 and aiming at the light confinement effect is adopted.

(Film-Forming Apparatus)

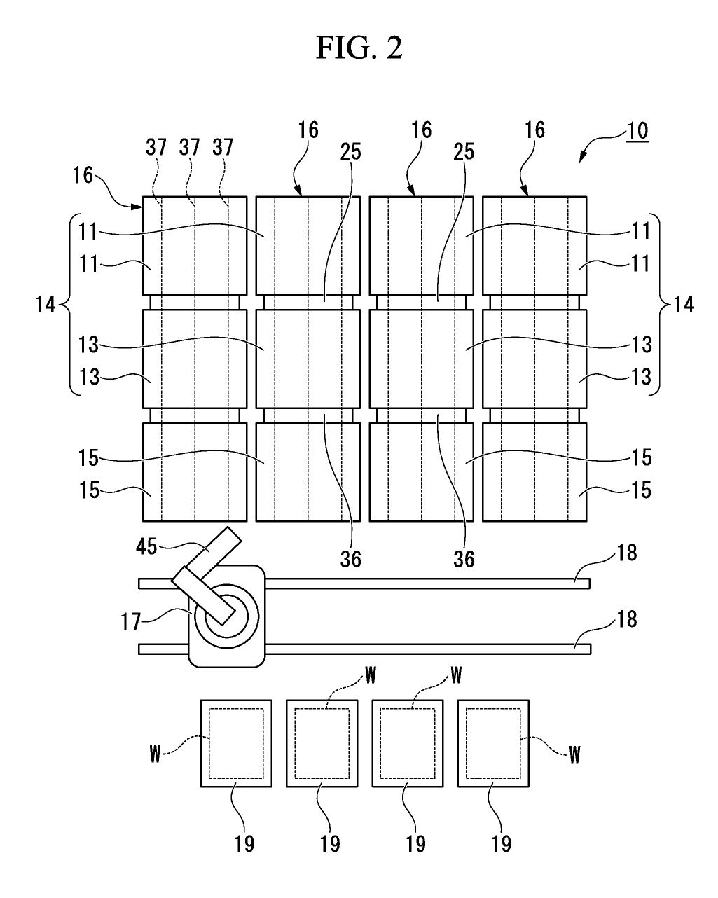

FIG. 2 is a schematic configuration view showing an example of the film-forming apparatus (apparatus for manufacturing a thin-film solar cell) of the invention.

As shown in FIG. 2, the film-forming apparatus 10 includes a film-forming chamber 11 in which a film (for example, the bottom cell 104 formed of microcrystalline silicon) can be simultaneously formed on a plurality of substrates W by using a CVD method, a loading and unloading chamber 13 that can simultaneously accommodate a substrate W1 before film forming processing that is carried into the film-forming chamber 11 and a substrate W2 after film forming processing that is carried out from the film-forming chamber 11, a substrate attachment and detachment chamber 15 in which the substrates W (the substrate W1 before film forming processing and the substrate W2 after film forming processing) are attached to and detached from a carrier 21 (refer to FIG. 9), a substrate attachment and detachment robot (driving mechanism) 17 for attaching and detaching the substrates W to/from the carrier 21 (refer to FIG. 9), and a substrate accommodating cassette (conveying part) 19 that accommodates the substrates W in order to convey the substrates to another processing process.

In the present embodiment, four substrate film formation lines 16 which are respectively constituted by the film-forming chamber 11, the loading and unloading chamber 13, and the substrate attachment and detachment chamber 15 are provided.

The substrate attachment and detachment robot 17 is able to move on rails 18 that are laid on the floor surface and is able to transfer the substrates W to all the substrate film formation lines 16 by one substrate attachment and detachment robot 17.

A process module 14 constituted by the film-forming chamber 11 and the loading and unloading chamber 13 are unified and is formed with a size such that the process module can be carried on a truck.

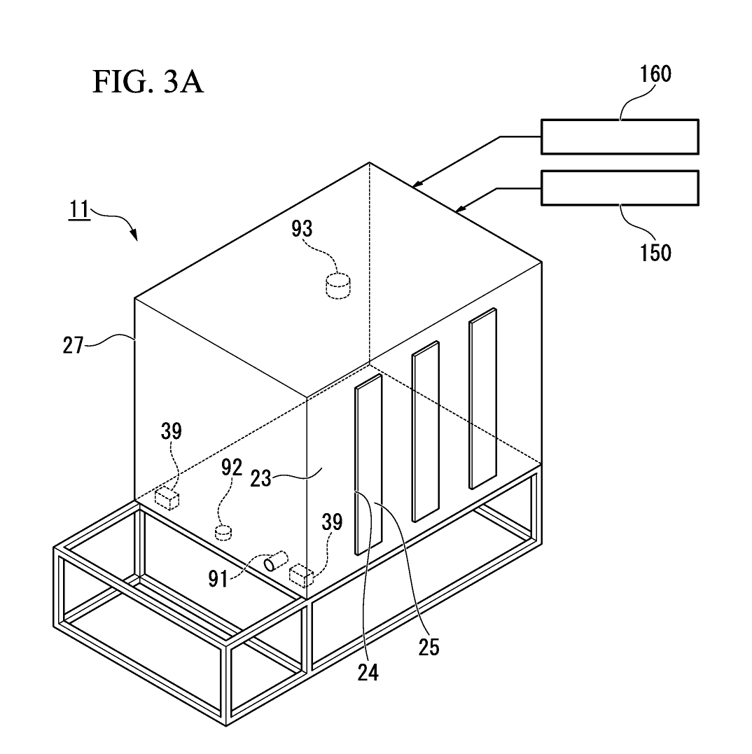

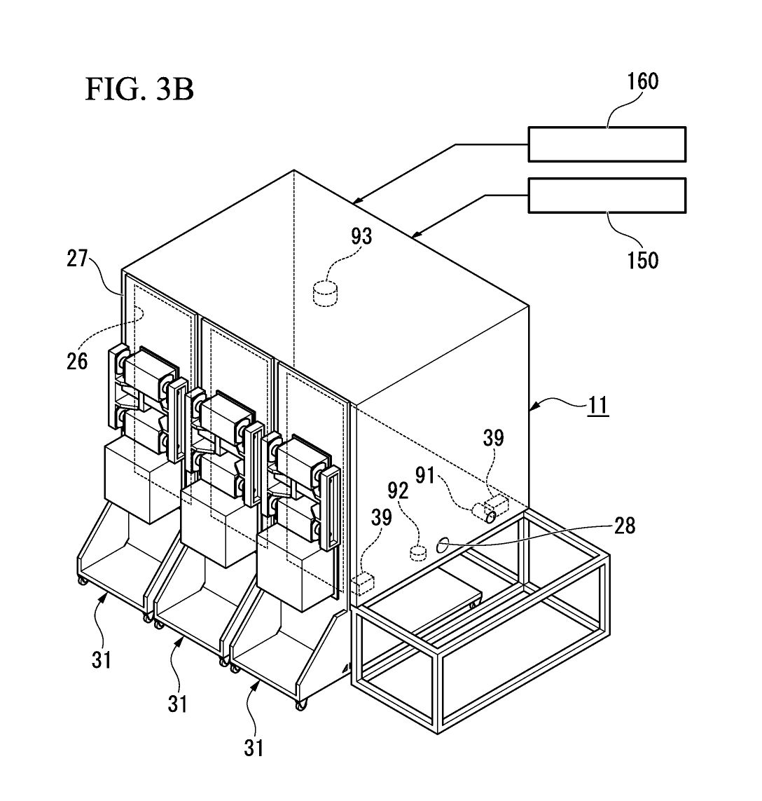

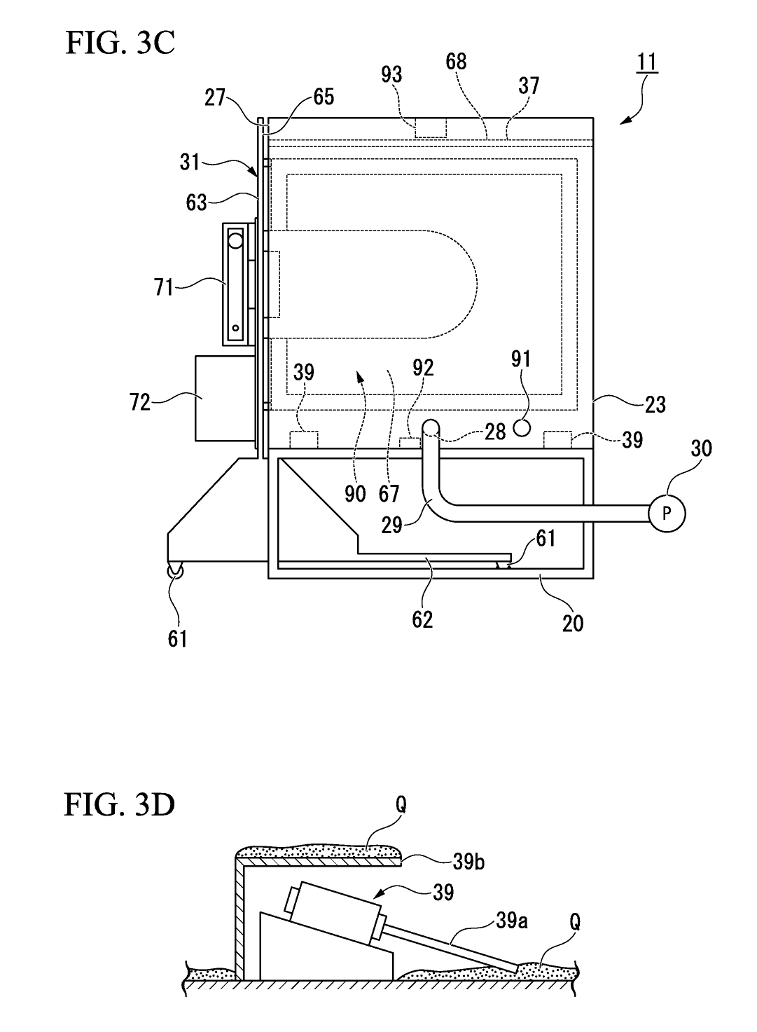

FIG. 3A is a perspective view showing the schematic configuration of the film-forming chamber. FIG. 3B is a perspective view as seen from an angle different from FIG. 3A. FIG. 3C is a side view showing the schematic configuration of the film-forming chamber.

As shown in FIGS. 3A to 3C, the film-forming chamber 11 is formed in a substantially box shape. Three carrying ports 24 through which carriers 21 on which the substrates W are mounted can pass are formed in a side surface 23 of the film-forming chamber 11 connected with the loading and unloading chamber 13. The carrying port 24 is provided with a shutter (first opening and closing part) 25 that opens and closes the carrying port 24.

When the shutter 25 is closed, the carrying port 24 is closed so as to ensure airtightness. Three electrode units 31 for forming a film on the substrates W are attached to a side surface 27 that is opposed to the side surface 23. The electrode units 31 are structured so as to be attachable and detachable from the film-forming chamber 11.

An evacuation pipe 29 for evacuating of the inside of the film-forming chamber 11 is connected to a side surface lower portion 28 of the film-forming chamber 11, and the evacuation pipe 29 is provided with a vacuum pump 30.

Four ignition sections 39 in total are respectively provided at four corners of the bottom surface of the film-forming chamber 11. The ignition section 39 may be constituted by a SiC heater including red heat portion 39a with a rod-shape exposed to the inside of the film-forming chamber 11, for example, as shown in FIG. 3D.

For example, the SiC heater can heat the red heat portion 39a to about 1100° C. A flowing current is applied to the ignition section 39 when a flammable by-product as described below is ignited.

It is preferable that portions other than red heat portion 39a of the ignition section 39 is covered with a cover 39b of metal or the like, for example, so that the by-product is not piled up directly in the film-forming chamber 11.

It is preferable that the red heat portion 39a of the ignition section 39 is inclined and provided so that the tip end thereof extends toward the bottom surface of the film-forming chamber 11. Thereby, the flammable by-product Q piled up on the bottom surface of the film-forming chamber 11 can be reliably ignited.

A pressure gauge (first detecting section) 91 for measuring the pressure in the film-forming chamber 11 is installed in the side surface 23 of the film-forming chamber 11. The pressure gauge 91 may measure the pressure in the range from vacuum to ordinary pressure and outputs a pressure value in the film-forming chamber 11.

A lower thermometer (second detecting section) 92 is installed in the vicinity of the middle of each side of the bottom surface of the film-forming chamber 11. The lower thermometer 92 may be constituted by, for example, a thermocouple. The lower thermometers 92 measure the temperature when the by-product piled up on the lower portion of the film-forming chamber 11 after film formation is burned and may be attached to, for example, a height position such that a sensor portion of the thermocouple is buried in the by-product when the by-product is piled up on the film-forming chamber 11.

It is preferable that the lower thermometer 92 is installed at a midpoint between the ignition sections 39 of the respective sides of the bottom surface of the film-forming chamber 11. This is, since the lower thermometer 92 may be used in order to confirm completion of burning of the by-product, it is preferable that the lower thermometer 92 is installed in a portion where spread of a fire to the by-product is the slowest.

The by-product is much piled up at the portion where the spread of the fire to the by-product is the slowest, and the portion often becomes the vicinity of the middle of each side of the bottom surface apart from the ignition sections 39.

If the installation position of the lower thermometer 92 comes into contact with the by-product piled up on the lower portion, burning of the by-product piled up on the lower portion can be confirmed.

An upper thermometer (third temperature detecting section) 93 that measures the spatial temperature in the film-forming chamber 11 is installed at an upper portion of the film-forming chamber 11. The upper thermometer 93 may be constituted by, for example, a thermocouple.

The upper thermometer 93 measures the spatial temperature in the film-forming chamber 11, that is, the temperature of gas in the film-forming chamber 11 when the by-product is burned. For this reason, it is preferable that the upper thermometer 93 is installed as close to the center as possible in the upper portion of the film-forming chamber 11. However, in a case where conveying parts for the substrate or the carrier are installed, the upper thermometer 93 may be installed between the conveying parts.

When ignited by the ignition sections 39, the inside of the film-forming chamber has a high temperature in an instant by the burning of gas in the film-forming chamber 11. The upper thermometer 93 can detect an ignition situation by confirming this temperature rise.

An oxygen gas charging section (first gas charging section) 160 that introduces oxygen gas into the film-forming chamber 11, and a nitrogen gas charging section (second gas charging section) 150 that introduces nitrogen gas into the film-forming chamber 11 are connected to the film-forming chamber 11.

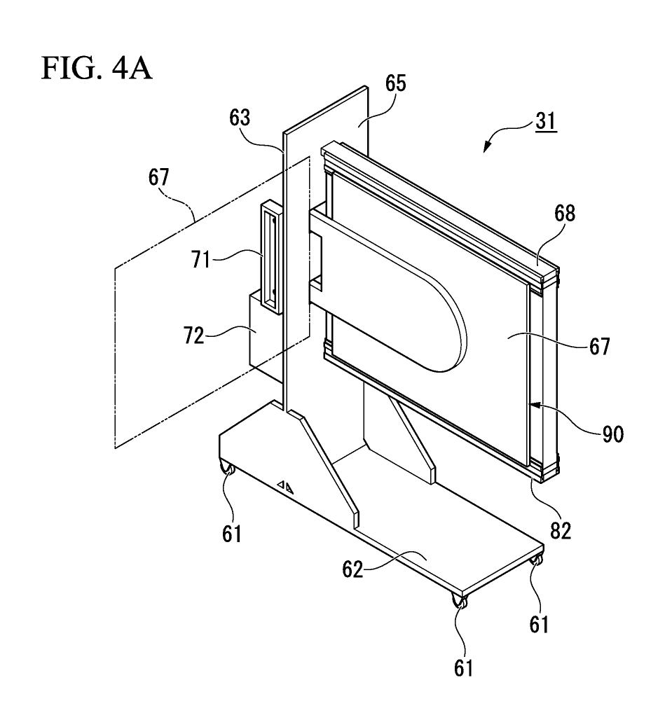

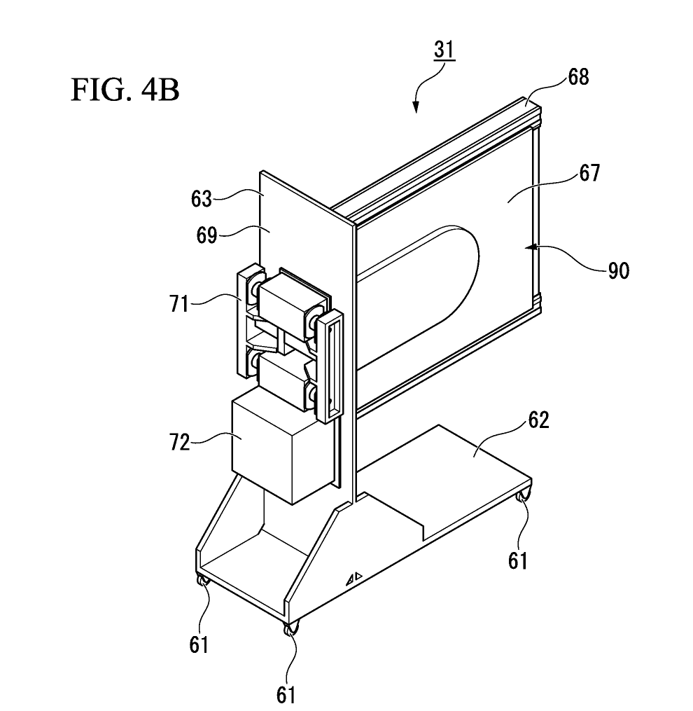

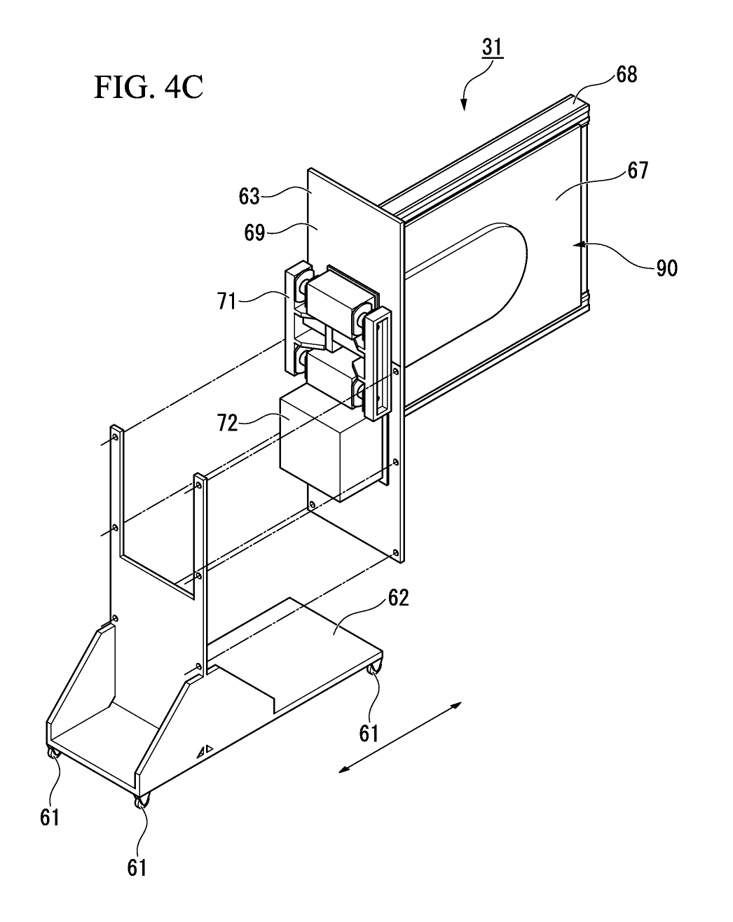

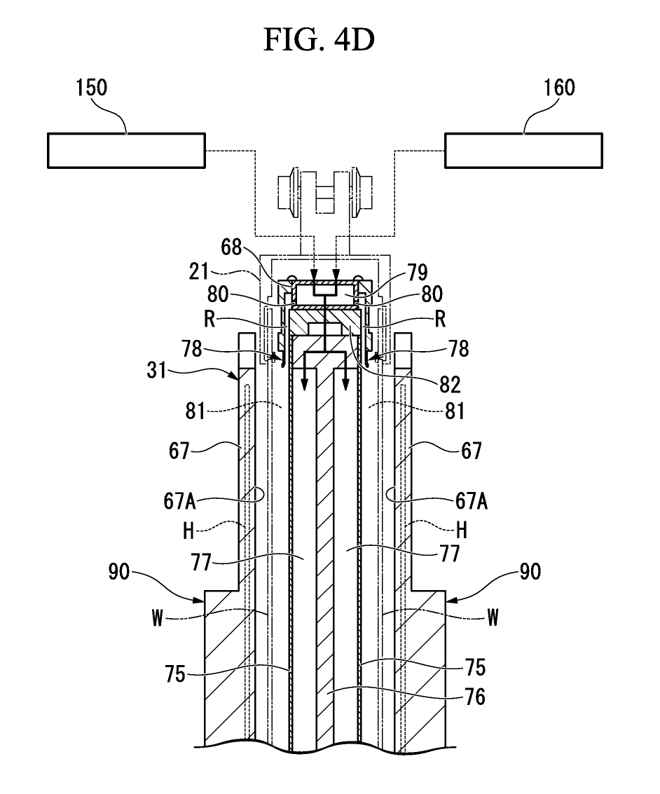

The oxygen gas charging section 160 or the nitrogen gas charging section 150 is supplied to a cathode unit 68 (refer to FIG. 4D) as described below of the film-forming chamber 11 through pipes (not shown).

The introduction positions of the oxygen gas charging section 160 and the nitrogen gas charging section 150 are not limited to the cathode unit 68, and may be introduced into the film-forming chamber 11. Moreover, the introduction positions of the oxygen gas charging section 160 and the nitrogen gas charging section 150 may be different.

FIG. 4A is a perspective view showing the schematic configuration of the electrode unit 31. FIG. 4B is a perspective view as seen from an angle different from FIG. 4A. FIG. 4C is a partial exploded perspective view of the electrode unit 31. FIG. 4D is a partial cross-sectional view of a cathode unit and an anode unit.

The electrode unit 31 is structured to be attachable and detachable from each of three opening portions 26 formed in the side surface 27 of the film-forming chamber 11 (refer to FIG. 3B).

The electrode unit 31 is structured to have wheels 61 provided at a lower portion thereof and to be movable on the floor surface.

A side plate portion 63 is erected in the vertical direction from a bottom plate portion 62 to which the wheels 61 are attached. The side plate portion 63 has a size such that the side plate portion 63 blocks the opening portion 26 of the side surface 27 of the film-forming chamber 11. That is, the side plate portion 63 forms a portion of the wall surface of the film-forming chamber 11.

As shown in FIG. 4C, the bottom plate portion 62 with the wheels 61 may have a carriage structure capable of being separated from and connected to the electrode unit 31. Thus, by adopting the separable carriage structure as described above, a carriage can be separated after the electrode unit 31 is connected to the film-forming chamber 11 and can be used as a common carriage for movement of other electrode units 31.

One surface (surface facing the inside of the film-forming chamber 11) 65 of the side plate portion 63 is provided with an anode unit 90 and the cathode unit 68 that are located on both sides of a substrate W when the film forming is performed. In the electrode unit 31 of the present embodiment, the anode units 90 are arranged apart from each other with the cathode unit 68 therebetween, so that the film forming can be simultaneously performed on two substrates W by one electrode unit 31.

Accordingly, substrates W are arranged on both surfaces of the cathode unit 68 so as to face each other in a state where the substrates become substantially parallel to the direction of gravitational force. And the two anode units 90 are arranged in a state where the anode units 90 face the substrates W in the outside of the respective substrates W in the thickness direction. The anode unit 90 is constituted by an anode 67 with a plate-shape and a heater H built in the anode unit 90.

A drive unit 71 for driving the anode units 90 and a matching box 72 for supplying electric power to a cathode intermediate member 76 of the cathode unit 68 when the film forming is performed are attached to the other surface 69 of the side plate portion 63. The side plate portion 63 is further formed with a connecting portion (not shown) for pipe that supplies a film forming gas to the cathode unit 68.

The heater H is built in the anode unit 90 as a temperature controller that controls the temperature of the substrate W.

The two anode units 90 are configured to be movable in a direction (horizontal direction) in which the anode units 90 approach and separate from each other by the drive unit 71 provided in the side plate portion 63 and are able to control the separation distance between the substrates W and the cathode unit 68.

Specifically, when the film forming is performed on substrates W, the two anode units 90 move in the direction of the cathode unit 68, come into contact the substrates W, and further move in the direction in which the anode units 90 approach the cathode unit 68 in order to regulate the separation distance between the substrates W and the cathode unit 68 to a desired distance.

Thereafter, the film forming is performed, and the anode units 90 move in the direction in which the anode units 90 separate from each other after the film forming in order to easily take out the substrates W from the electrode unit 31.

The anode unit 90 is attached to the drive unit 71 through a hinge (not shown), and is structured to turn (open) until a surface 67A at the side of the cathode unit 68 of the anode unit 90 (anode 67) becomes substantially parallel to one surface 65 of the side plate portion 63 in a state where the electrode unit 31 is pulled out from the film-forming chamber 11. That is, the anode unit 90 is able to turn approximately 90° in planar view (refer to FIG. 4A).

The cathode unit 68 has a shower plate 75 (=cathode), the cathode intermediate member 76, an evacuation duct 79, and a floating capacitor 82.

The oxygen gas charging section (first gas charging section) 160 or the nitrogen gas charging section (second gas charging section) 150 is connected to the cathode unit 68 through pipes (not shown).

The shower plate 75 in which a plurality of small holes (not shown) is formed is arranged on the surface that faces the anode unit 90 (anode 67) so that the film forming gas can be jetted toward the substrate W.

In addition, in the embodiment, the oxygen gas charging section (first gas charging section) 160 or the nitrogen gas charging section (second gas charging section) 150 is jetted from the shower plate 75 of the cathode unit 68 when the gas is introduced into the film-forming chamber 11. However, in addition to the above, for example, the oxygen gas or the nitrogen gas may be directly introduced into the film-forming chamber 11 from a gas introduction port formed in the wall surface of the film-forming chamber 11. For example, a configuration may be adopted in which pipe that passes cleaning gas in the film-forming chamber 11 is provided and the oxygen gas or the nitrogen gas is introduced into the film-forming chamber 11 by using the pipe.

The oxygen gas and the nitrogen gas that are supplied from the oxygen gas charging section 160 and the nitrogen gas charging section 150 can be introduced into the film-forming chamber 11 from the shower plate 75.

The shower plates 75 are cathodes (high-frequency electrodes) connected to the matching box 72.

The cathode intermediate member 76 connected to the matching box 72 is provided between the two shower plates 75.

That is, the shower plates 75 are arranged on both side surfaces of the cathode intermediate member 76 in a state where the shower plates 75 are electrically connected to the cathode intermediate member 76. The cathode intermediate member 76 and the shower plates (cathodes) 75 are formed of electric conductors, and a high frequency is applied to the shower plates (cathodes) 75 through the cathode intermediate member 76. For this reason, voltage of the same potential and the same phase for generating plasma is applied to the two shower plates 75.

The cathode intermediate member 76 is connected to the matching box 72 by wiring (not shown). A space portion 77 is formed between the cathode intermediate member 76 and the shower plate 75, and the film forming gas is supplied through the space portion 77 from a gas supply device (not shown). Additionally, the oxygen gas and the nitrogen gas are supplied through the space portion 77.

The space portion 77 is separated by the cathode intermediate member 76. The space portions 77 are separately formed so as to correspond to the each shower plates 75, and the gases emitted from the each shower plates 75 are independently controlled. That is, the space portions 77 have a role of gas supply routes.

In the embodiment, since the space portions 77 are separately formed so as to correspond to the each shower plates 75, the cathode unit 68 has two gas supply routes.

An evacuation duct 79 with the hollow is provided over approximately the whole circumference of the peripheral edge portion of the cathode unit 68. The evacuation duct 79 is formed with an evacuation port 80 for evacuating the film forming gas or reaction by-product (powder) of the film-forming space 81.

Specifically, the evacuation port 80 is formed so as to face the film-forming space 81 formed between the substrate W and the shower plate 75 when the film forming is performed.

A plurality of evacuation ports 80 are formed along the peripheral edge portion of the cathode unit 68 and are structured to be able to perform the evacuation equally over approximately the whole circumference.

An opening portion (not shown) is formed in a surface 82 of the evacuation duct 79 that is directed to the inside of the film-forming chamber 11 in the lower portion of cathode unit 68 so that the evacuated film forming gas or the like can be discharged into the film-forming chamber 11.

The gas discharged into the film-forming chamber 11 is evacuated to the outside through the evacuation pipe 29 provided in the side surface lower portion 28 of the film-forming chamber 11. The floating capacitor 82 that has a dielectric and/or a laminating space is provided between the evacuation duct 79 and the cathode intermediate member 76. The evacuation duct 79 is connected to ground potential. The evacuation duct 79 also functions as a shield frame for preventing abnormal discharging from the cathode 75 and the cathode intermediate member 76.

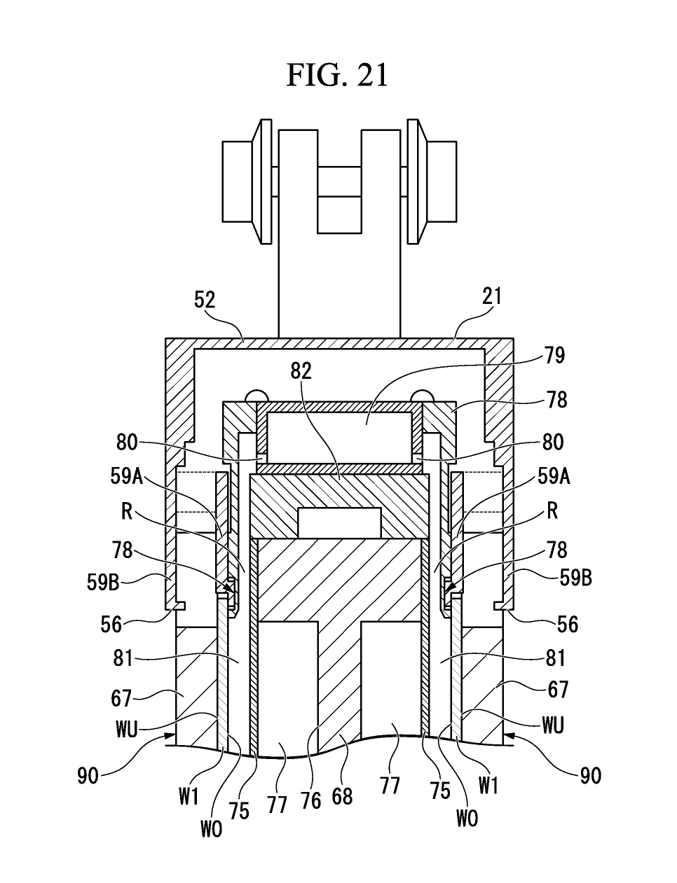

A mask 78 is provided at the peripheral edge portion of the cathode unit 68 so as to cover a region from the outer peripheral portion of the evacuation duct 79 to the outer peripheral portion of the shower plate 75 (=cathode). The mask 78 covers a pinching piece 59A (refer to FIGS. 9 and 21) of a pinching portion 59 provided in the carrier 21 as described below and is unified with the pinching piece 59A when the film forming is performed in order to form a gas flow route R for guiding the film forming gas or particles in the film-forming space 81 to the evacuation duct 79. That is, the gas flow route R is formed between the carrier 21 (pinching piece 59A) and the shower plate 75 and between the carrier 21 and the evacuation duct 79.

By providing the electrode unit 31, two gaps between the anode units 90 and cathode unit 68 into which the substrates W are inserted are formed in one electrode unit 31. Accordingly, the film forming can be performed simultaneously on two substrates W by one electrode unit 31.

As shown in FIG. 2, movement rails 37 are laid between the film-forming chamber 11 and the substrate attachment and detachment chamber 15 so that the carrier 21 can move between the film-forming chamber 11 and the loading and unloading chamber 13 and between the loading and unloading chamber 13 and the substrate attachment and detachment chamber 15. The movement rails 37 are separated between the film-forming chamber 11 and the loading and unloading chamber 13, and the carrying port 24 can be sealed by closing the shutter 25.

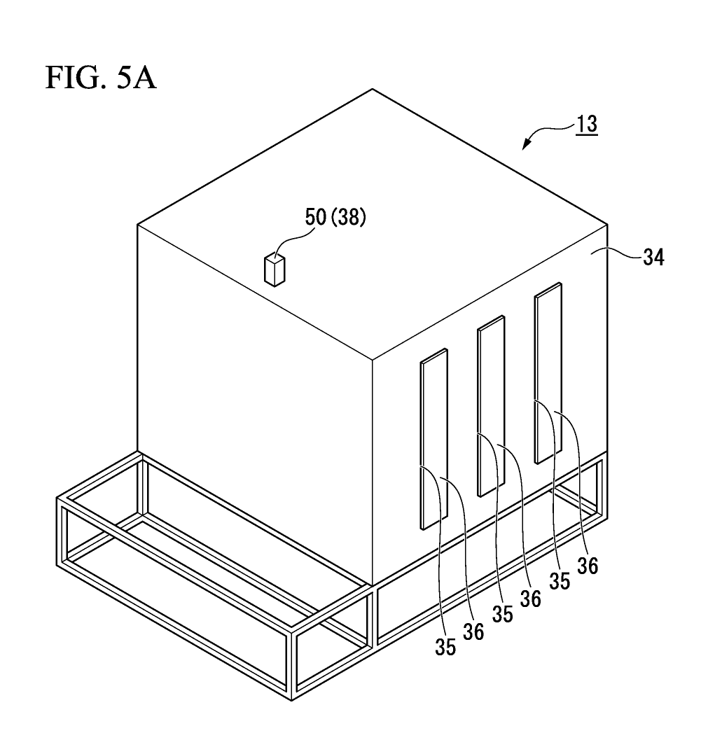

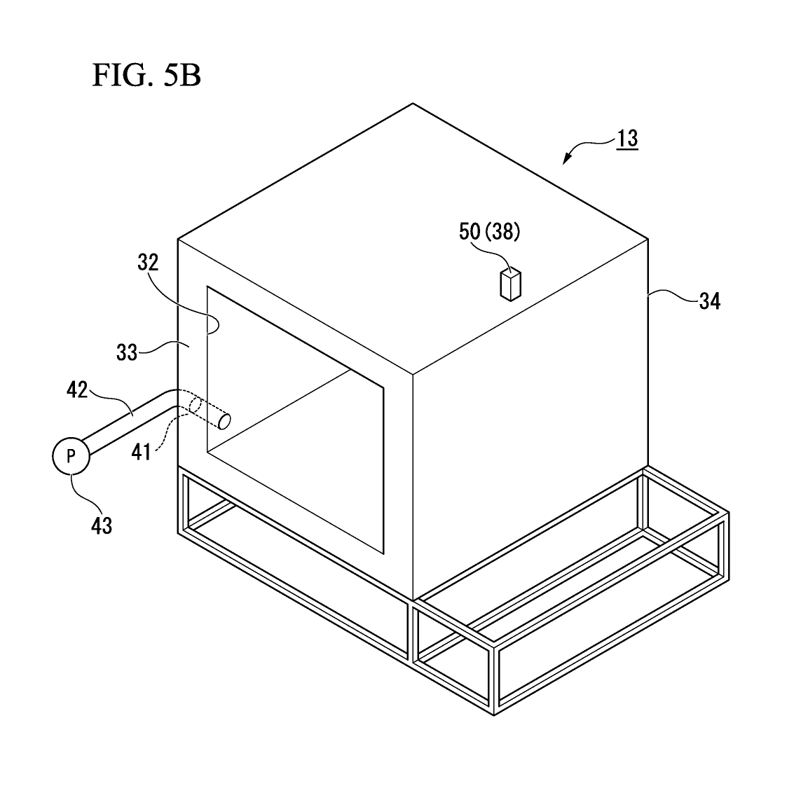

FIG. 5A is a perspective view showing the schematic configuration of the loading and unloading chamber 13. FIG. 5B is a perspective view as seen from an angle different from FIG. 5A. As shown in FIGS. 5A and 5B, the loading and unloading chamber 13 is formed in a box shape. The side surface 33 is connected with the side surface 23 of the film-forming chamber 11 so as to ensure airtightness. The side surface 33 is formed with opening portions 32 through which three carriers 21 can be inserted.

A side surface 34 that is opposed to the side surface 33 is connected to the substrate attachment and detachment chamber 15. Three carrying ports 35 through which the carriers 21 with the substrate W are mounted can pass are formed in the side surface 34. The carrying port 35 is provided with a shutter (second opening and closing part) 36 that can ensure airtightness. The movement rails 37 are separated between the loading and unloading chamber 13 and the substrate attachment and detachment chamber 15, and the carrying port 35 can be sealed by closing the shutter 36.

The loading and unloading chamber 13 is provided with a push-pull mechanism 38 for moving the carrier 21 between the film-forming chamber 11 and the loading and unloading chamber 13 along the movement rails 37.

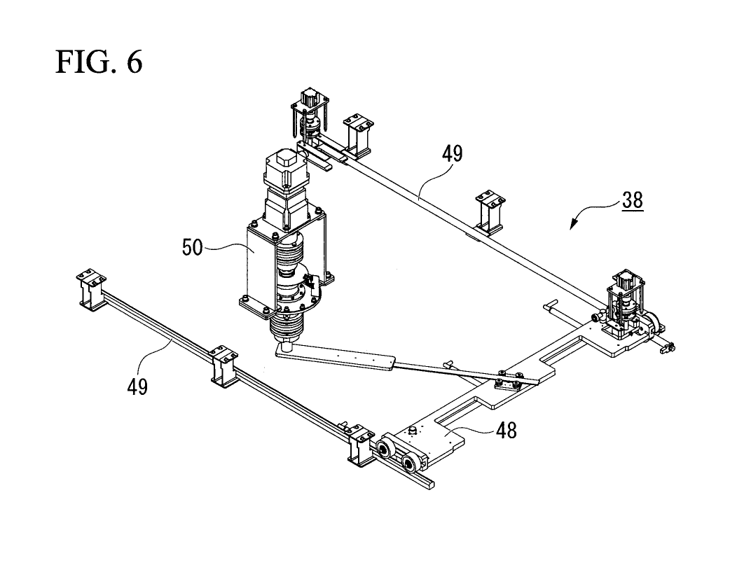

As shown in FIG. 6, the push-pull mechanism 38 includes a locking part 48 for locking the carrier 21, guide members 49 provided at both ends of the locking part 48 and arranged substantially parallel to the movement rails 37, and a moving device 50 for moving the locking part 48 along the guide members 49.

In order to accommodate the substrate W1 before film forming processing and the substrate W2 after film forming processing simultaneously, a moving mechanism (not shown) for moving the carrier 21 by a predetermined distance in a direction substantially orthogonal to the laying direction of the movement rails 37 in planar view is provided in the loading and unloading chamber 13. An evacuation pipe 42 for evacuating the inside of the loading and unloading chamber 13 is connected to the side surface lower portion 41 of the loading and unloading chamber 13, and the evacuation pipe 42 is provided with a vacuum pump 43.

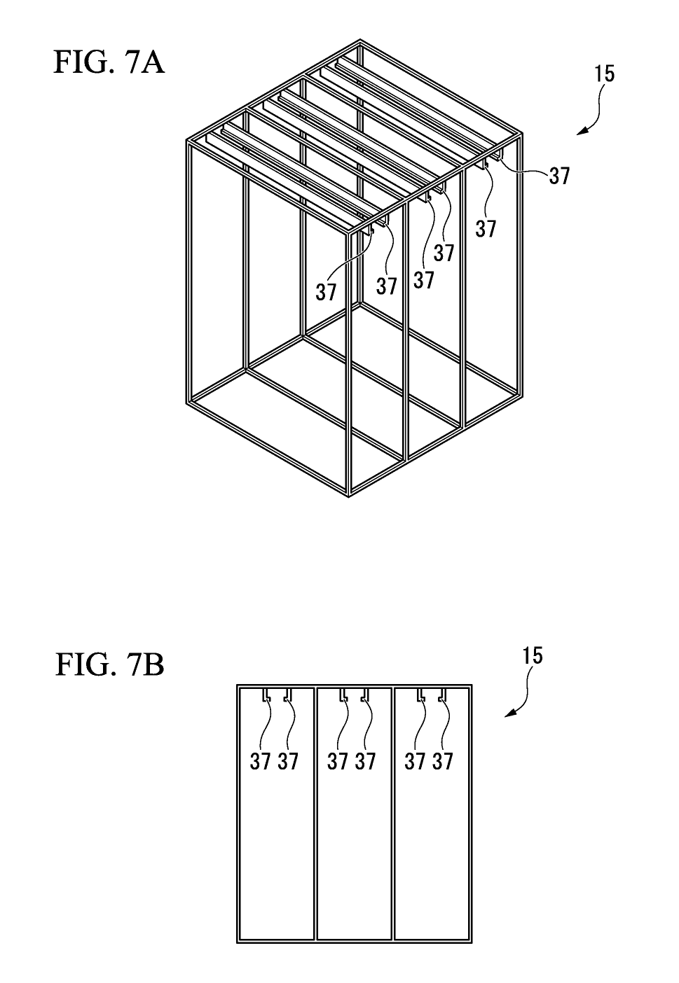

FIG. 7A is a perspective view showing the schematic configuration of the substrate attachment and detachment chamber. FIG. 7B is a front view showing the schematic configuration of the substrate attachment and detachment chamber. As shown in FIGS. 7A and 7B, the substrate attachment and detachment chamber 15 is formed in the shape of a frame and is connected to the side surface 34 of the loading and unloading chamber 13. In the substrate attachment and detachment chamber 15, the substrate W1 before film forming processing can be attached to the carrier 21 arranged on the movement rails 37, and the substrate W2 after film forming processing can be removed from the carrier 21. Three carriers 21 are configured to be able to be arranged in parallel in the substrate attachment and detachment chamber 15.

The substrate attachment and detachment robot 17 has a drive arm 45 (refer to FIG. 2) and can suction the substrate W at the tip end of the drive arm 45. The drive arm 45 is able to be driven between the carrier 21 arranged in the substrate attachment and detachment chamber 15 and the substrate accommodating cassette 19. The drive arm 45 takes out the substrate W1 before film forming processing from the substrate accommodating cassette 19, attaches the substrate W1 before film forming processing to a carrier (first carrier) 21 arranged in the substrate attachment and detachment chamber 15, detaches the substrate W2 after film forming processing from a carrier (second carrier) 21 that has returned to the substrate attachment and detachment chamber 15, and transfers to the substrate accommodating cassette 19.

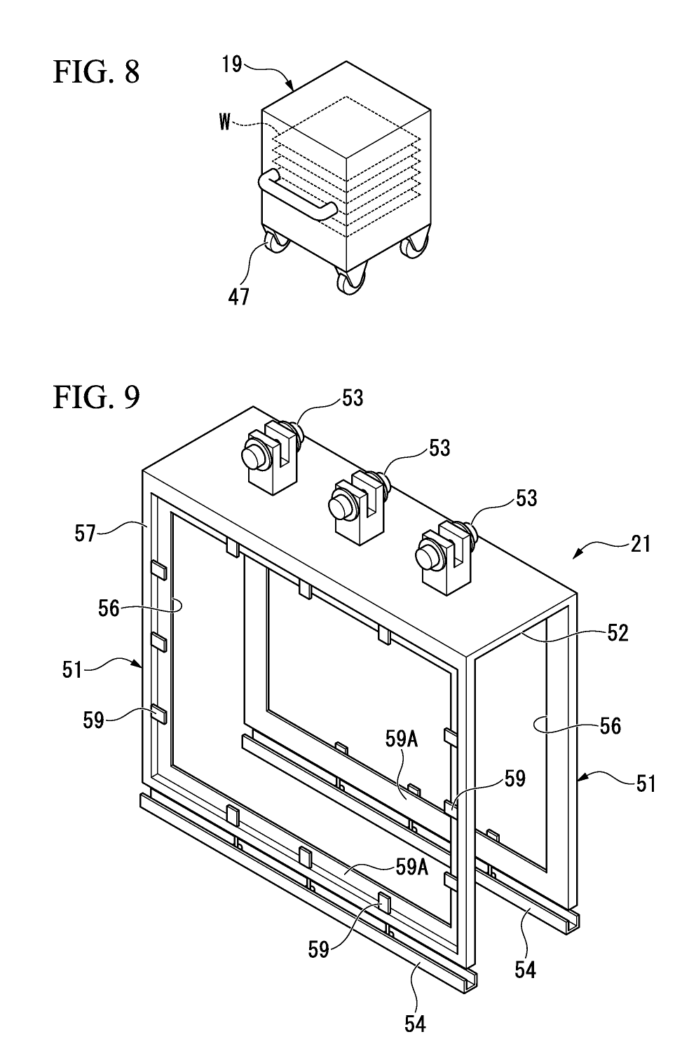

FIG. 8 is a perspective view of the substrate accommodating cassette 19. As shown in FIG. 8, the substrate accommodating cassette 19 is formed in a box shape and has a size to be able to accommodate a plurality of substrates W. The plurality of substrates W can be accommodated so as to be stacked in the vertical direction in a state where film-formed surfaces become substantially parallel to the horizontal direction.

Casters 47 are provided at a lower portion of the substrate accommodating cassette 19 so as to move to another processing apparatus. In addition, a plurality of substrates W may be able to be accommodated in a right-and-left direction in the substrate accommodating cassette 19 in a state where film-formed surfaces thereof become substantially parallel to the direction of gravitational force.

FIG. 9 is a perspective view of the carrier 21. As shown in FIG. 9, the carrier 21 is formed with two frames 51 with a frame-shape that can attach the substrates W. That is, two substrates W can be attached to one carrier 21. The two frames 51 are unified by a coupling member 52 at the upper portions thereof. Wheels 53 to be placed on the movement rails 37 are provided above the coupling member 52, and the carrier 21 can be moved as the wheels 53 roll on the movement rails 37.

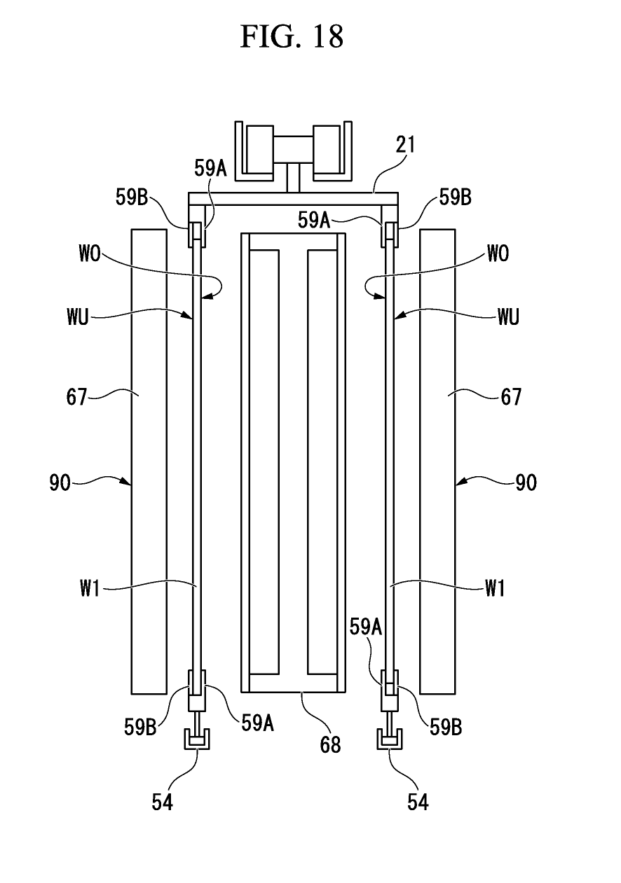

Frame holders 54 are provided at the lower portions of the frames 51 in order to suppress the shaking of the substrates W when the carrier 21 moves. The tip ends of the frame holders 54 are fitted to the rail members 55 (refer to FIG. 18) with a concave cross-section which are provided on the bottom surface of each chamber. The rail members 55 are arranged in a direction along the movement rails 37 in planar view. If the frame holders 54 are constituted by a plurality of rollers, more stable conveyance becomes possible.

Each frame 51 has a peripheral edge portion 57 and the pinching portion 59. A film-formed surface of the substrate W is exposed through an opening portion 56 formed in the frame 51 so that the pinching portion 59 pinches and fix the substrate W from both sides in the peripheral edge portion 57 of the opening portion 56.

A spring force generated by a spring or the like acts on the pinching portion 59 that pinches the substrate W.

Although the pinching portion 59 has pinching pieces 59A and 59B that contact with the front surface WO (film-formed surface) and the rear surface WU (back surface) of the substrate W (refer to FIG. 21), the separation distance of the pinching pieces 59A and 59B is made variable by springs or the like. That is, in accordance with the movement of the anode unit 90 (anode 67), the pinching piece 59A is structured to be movable along a direction in which the pinching piece 59A approaches and separates from the pinching piece 59B (the details will be described below). Here, one carrier 21 (one carrier that can hold one pair of (two) substrates) is attached on one movement rail 37. That is, three carriers (holding three pairs of (six) substrates) 21 are attached to a set of film-forming apparatuses 10.

Since four substrate film formation lines 16 which are respectively constituted by the film-forming chamber 11, the loading and unloading chamber 13, and the substrate attachment and detachment chamber 15 are arranged in the film-forming apparatus 10 of the present embodiment as described above, the film forming can be performed substantially on twenty four substrates W at the same time.

In addition, the present invention is not limited to the above-described embodiment, but that various modifications of the above-described embodiment may be made without departing from the aspect of the invention. That is, the specific shapes and configurations mentioned in the embodiment are merely examples and can be appropriately changed.

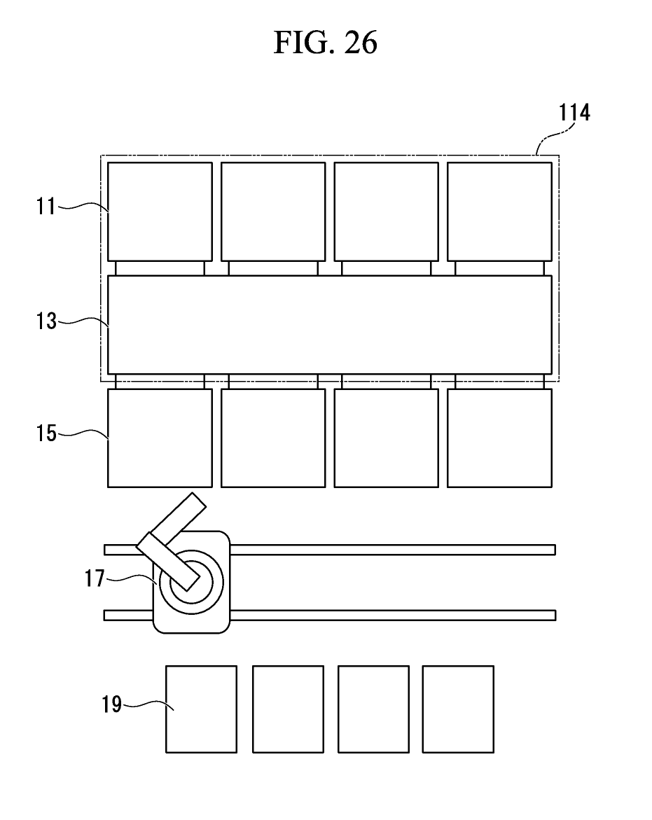

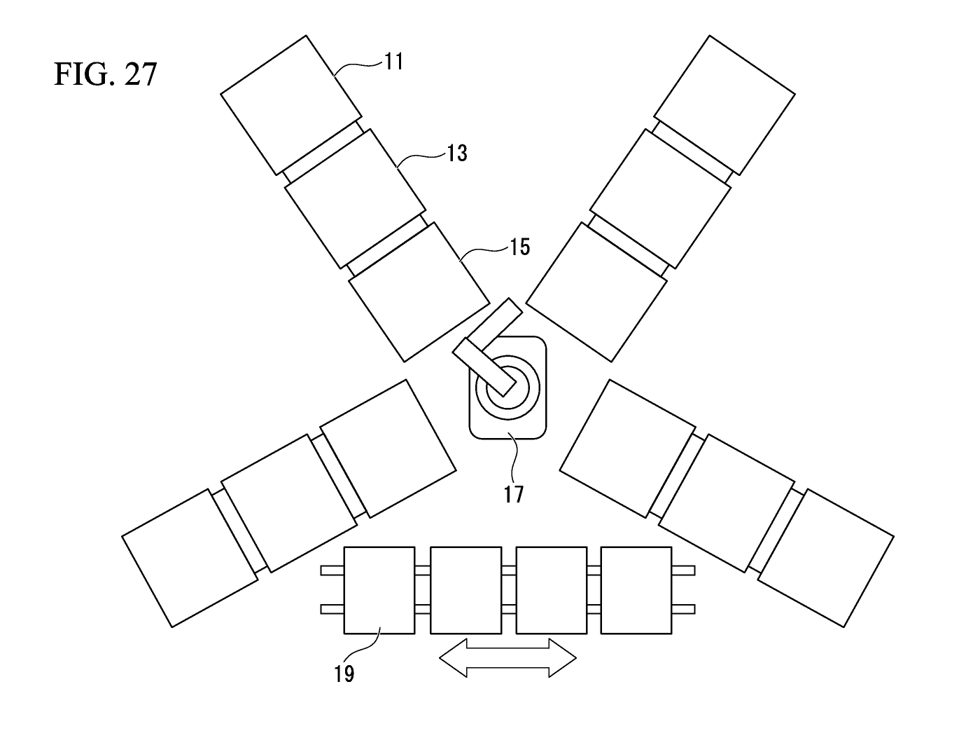

For example, although a case where the one loading and unloading chamber 13 which is connected to the one film-forming chamber 11 has been described in the present embodiment, a process module 114 in which a plurality of film-forming chambers 11 are arranged in parallel and connected to one large loading and unloading chamber 13 may be provided so that the carrier 21 can move inside the loading and unloading chamber 13 (refer to FIG. 26). Since the substrates W attached to the carrier 21 can move in the loading and unloading chamber 13 by adopting the configuration, a plurality of layers with different film forming materials can be more efficiently formed on the substrates W by enabling different film forming materials to be supplied in the film-forming chambers 11.

Moreover, the arrangement of the apparatus for manufacturing a thin-film solar cell may be configured as shown in FIG. 27. In the example, modules each including the film-forming chamber 11, the loading and unloading chamber 13, and the substrate attachment and detachment chamber 15 are radially installed in the substrate attachment and detachment robot 17. By adopting the configuration, the time for which the substrate attachment and detachment robot 17 moves on the rails can be omitted. That is, cycle time can be shortened by shortening the operating time of the substrate attachment and detachment robot 17.

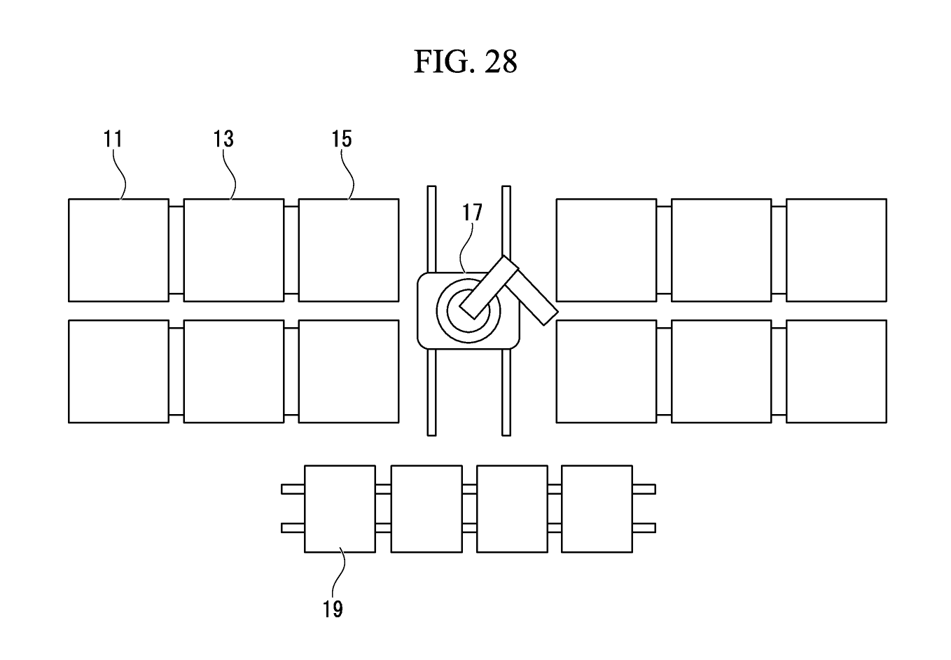

Moreover, the arrangement of the apparatus for manufacturing a thin-film solar cell may be configured as shown in FIG. 28. In the example, modules each including the film-forming chamber 11, the loading and unloading chamber 13, and the substrate attachment and detachment chamber 15 are installed on both sides the substrate attachment and detachment robot 17. By adopting the configuration, space can be saved, and the operating time of the substrate attachment and detachment robot 17 can be shortened.

In the present embodiment, one substrate attachment and detachment robot 17 is arranged and adapted to perform attachment and detachment of substrates W. However, two substrate attachment and detachment robots 17 may be arranged, one robot may be used exclusively for attachment of the substrate W, and the other robot may be used exclusively for detachment of the substrate W. Moreover, two drive arms 45 may be provided in one substrate attachment and detachment robot 17 so as to attach and detach two substrates W simultaneously.

(Film Forming Method: Method for Manufacturing Thin-Film Solar Cell)

Next, a method for forming a film on a substrate W by using the film-forming apparatus 10 of the present embodiment will be described. In addition, although the drawing of one substrate film formation line 16 is used in the description, the other three substrate film formation lines 16 also form the films on substrates W with almost the same flow.

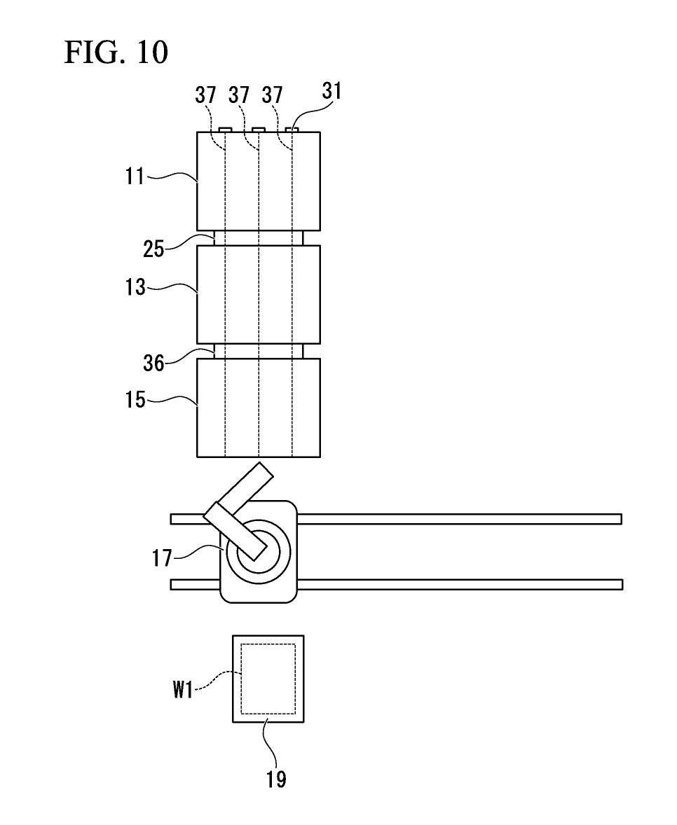

As shown in FIG. 10, the substrate accommodating cassette 19 that accommodates a plurality of substrates W1 before film forming processing is arranged at a predetermined position.

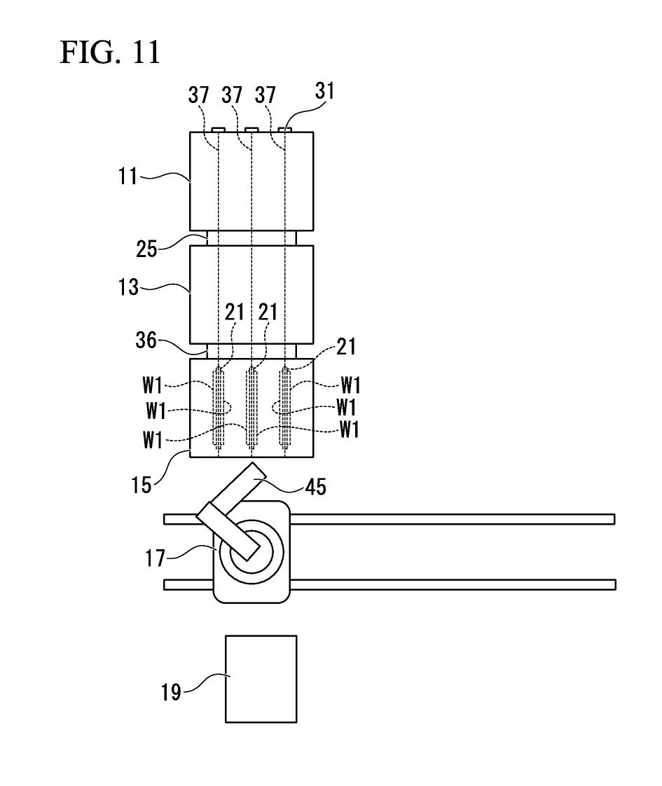

As shown in FIG. 11, the drive arm 45 of the substrate attachment and detachment robot 17 is moved to take out one substrate W1 before film forming processing from the substrate accommodating cassette 19 and attach the substrate W1 before film forming processing to the carrier 21 installed in the substrate attachment and detachment chamber 15. At this time, the substrate W1 before film forming processing that is arranged in the horizontal direction in the substrate accommodating cassette 19 is attached to the carrier 21 after the direction thereof is changed to the vertical direction. This operation is repeated once again and two substrates W1 before film forming processing are attached to the one carrier 21. Moreover, the operation is repeated and the substrates W1 before film forming processing are also attached to the two remaining carriers 21 installed in the substrate attachment and detachment chamber 15, respectively. That is, six substrates W1 before film forming processing are attached in the process.

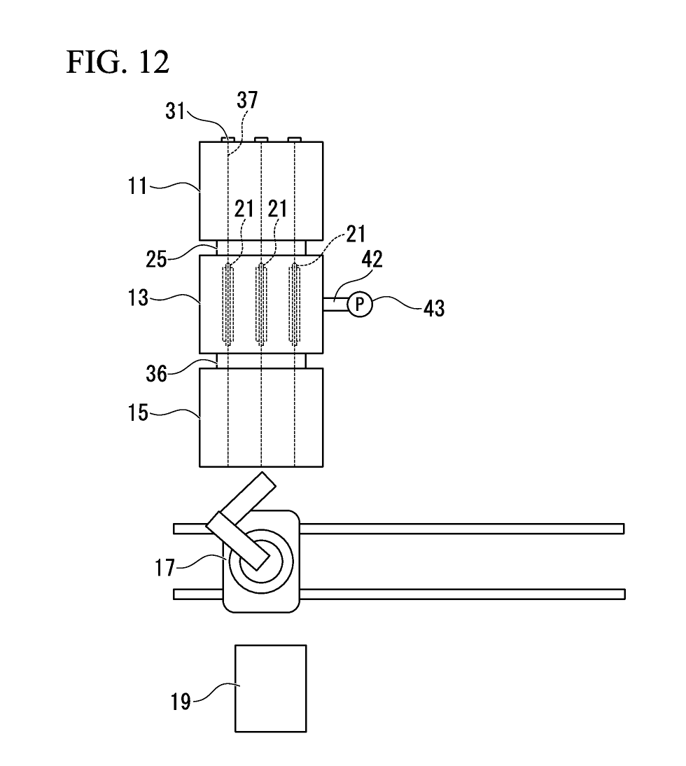

As shown in FIG. 12, three carriers 21 attached to the substrates W1 before film forming processing are approximately simultaneously moved along the movement rails 37 and are accommodated in the loading and unloading chamber 13. After the carriers 21 are accommodated in the loading and unloading chamber 13, the shutters 36 of the carrying ports 35 of the loading and unloading chamber 13 are closed. Then, the inside of the loading and unloading chamber 13 is held in a vacuum state by using the vacuum pump 43.

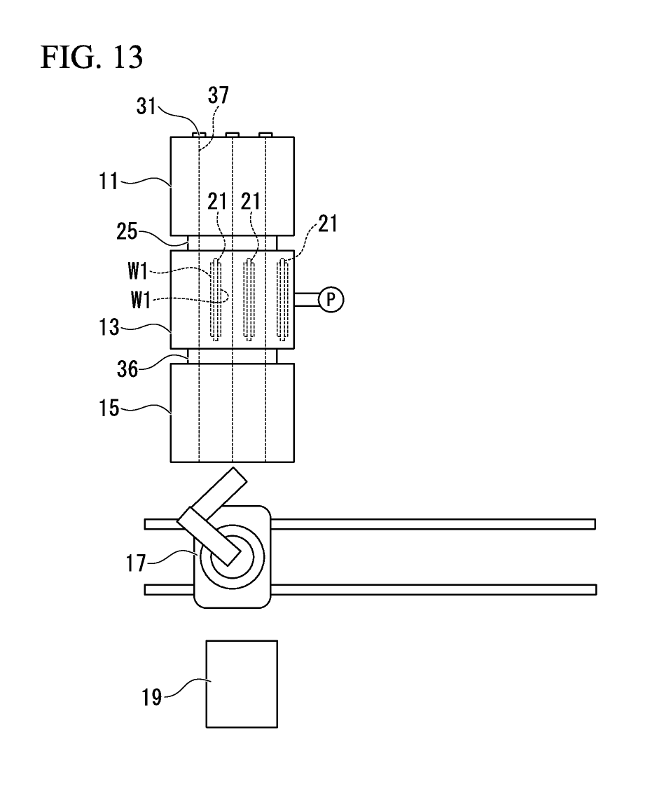

As shown in FIG. 13, the three carriers 21 are moved by a predetermined distance (half pitch), respectively, using a moving mechanism in a direction orthogonal to the direction in which the movement rails 37 are laid in planar view. The predetermined distance is a distance where one carrier 21 is located between adjacent movement rails 37.

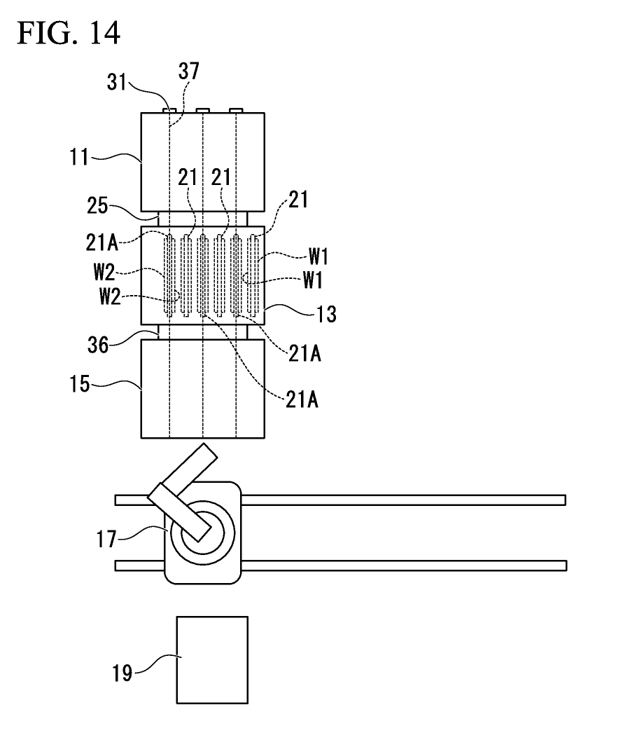

As shown in FIG. 14, the shutter 25 of the film-forming chamber 11 is brought into an open state, and carriers 21A which are attached to the substrates W2 after film forming processing for which the film forming has ended in the film-forming chamber 11 are moved to the loading and unloading chamber 13 by using the push-pull mechanism 38. At this time, the carriers 21 and the carriers 21A are arranged alternately in parallel in planar view. By holding in the state for a predetermined time, the heat that is accumulated in the substrate W2 after film forming processing is transferred to the substrates W1 before film forming processing, and the substrates W1 before film forming processing is heated.

Here, the movement of the push-pull mechanism 38 will be described. In addition, the movement when the carriers 21A located in the film-forming chamber 11 are moved to the loading and unloading chamber 13 will be described.

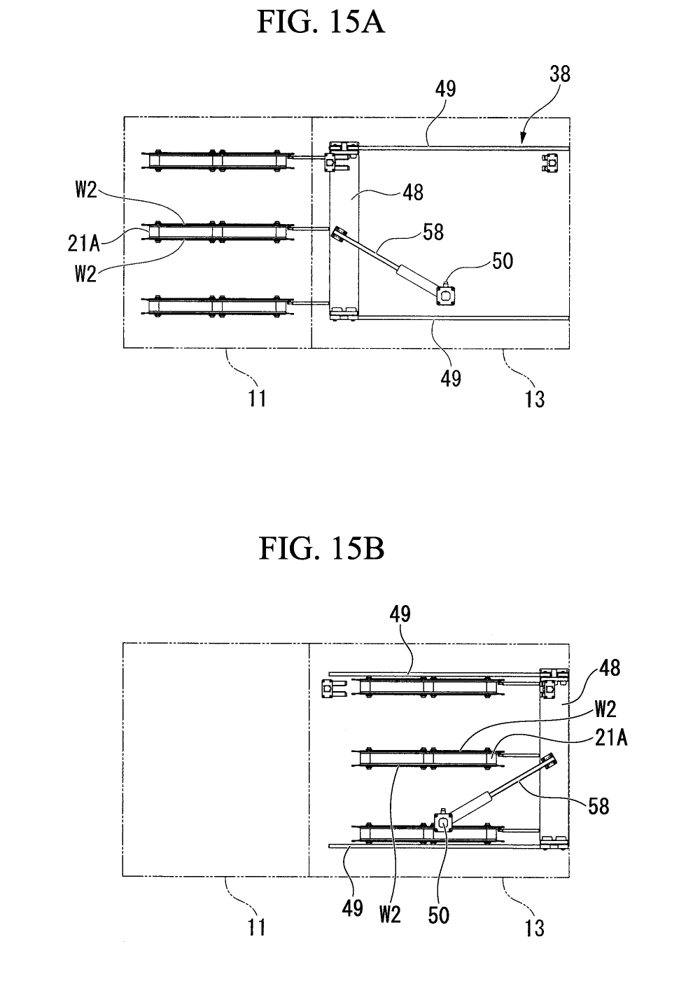

As shown in FIG. 15A, the carriers 21A to which the substrates W2 after film forming processing are attached is locked to the locking part 48 of the push-pull mechanism 38. Then, a movement arm 58 of the moving device 50 attached to the locking part 48 is rocked. At this time, the length of the movement arm 58 is variable.

Then, the locking part 48 to which the carriers 21A are locked moves so as to be guided by the guide members 49 and, as shown in FIG. 15B, moves into the loading and unloading chamber 13. That is, the carriers 21A are moved from the film-forming chamber 11 to the loading and unloading chamber 13. By adopting the configuration, a driving source for driving the carrier 21A becomes unnecessary in the film-forming chamber 11.

By performing the reverse movement of the above-described movement, the carriers of the loading and unloading chamber 13 can be moved to the film-forming chamber 11.

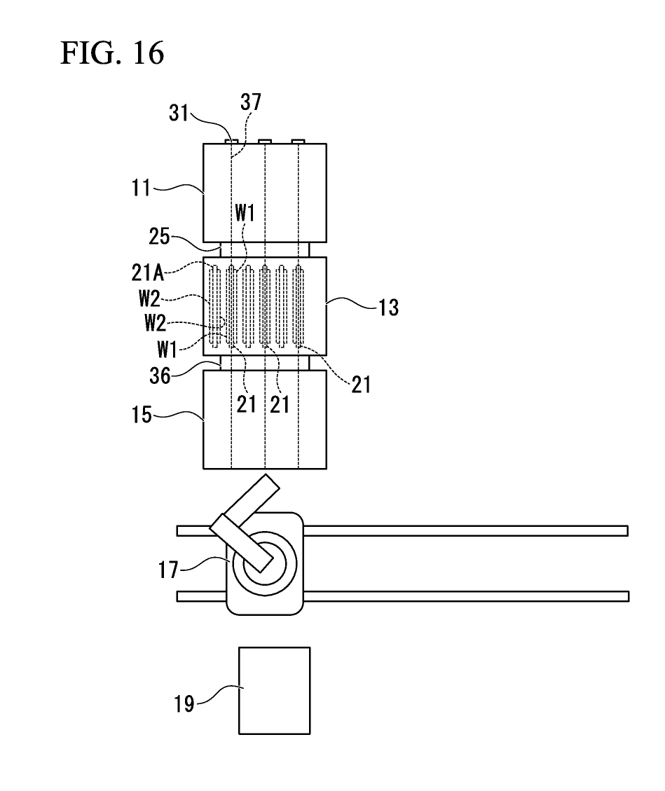

As shown in FIG. 16, the carriers 21 and the carriers 21A are moved in the direction orthogonal to the movement rails 37 by the moving mechanism, and the carriers 21 holding the substrates W1 before film forming processing are moved to the positions along the movement rails 37.

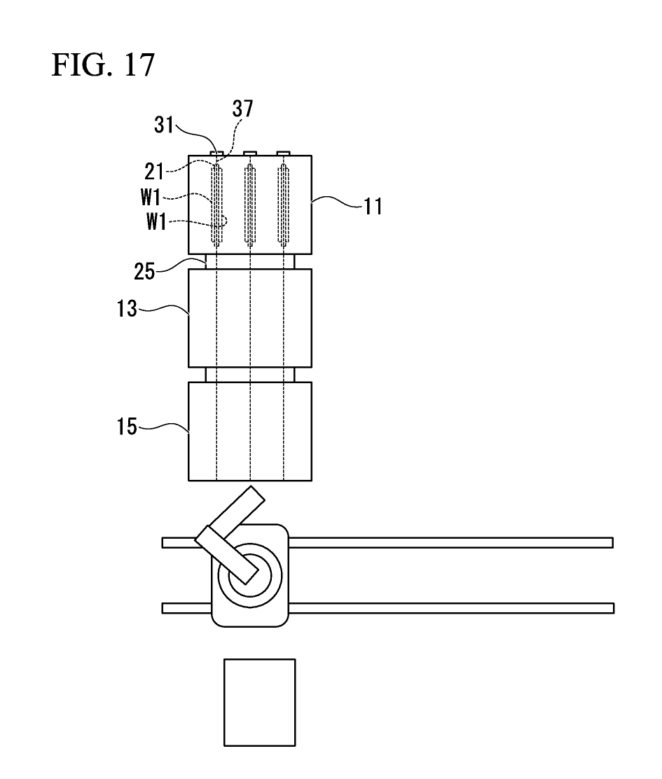

As shown in FIG. 17, the carriers 21 holding the substrates W1 before film forming processing are moved to the film-forming chamber 11 by using the push-pull mechanism 38, and the shutter 25 is brought into a closed state after completion of the movement. In addition, the film-forming chamber 11 is held in a vacuum state. At this time, the substrates W1 before film forming processing attached to the carriers 21 are inserted in a state along the vertical direction so that the front surfaces WO thereof become parallel to the direction of gravitational force between the anode units 90 and the cathode unit 68 in the film-forming chamber 11 (refer to FIG. 18).

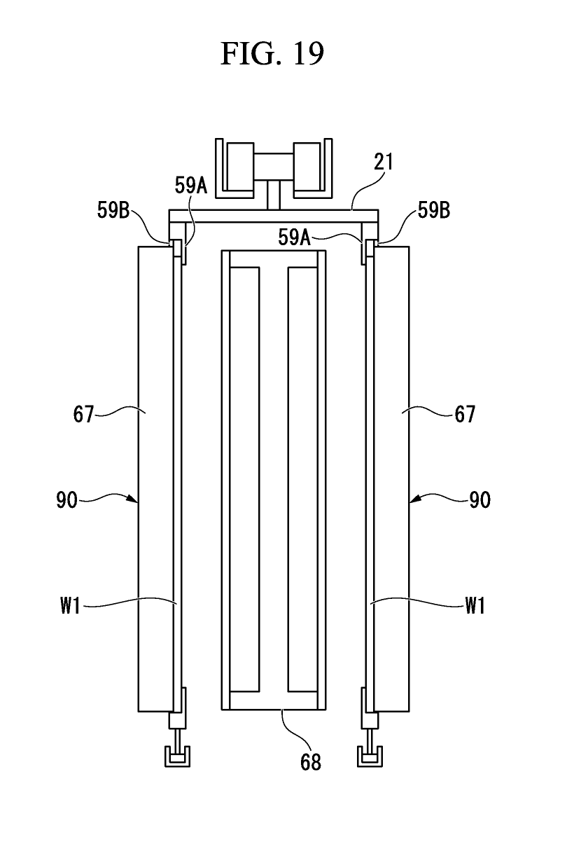

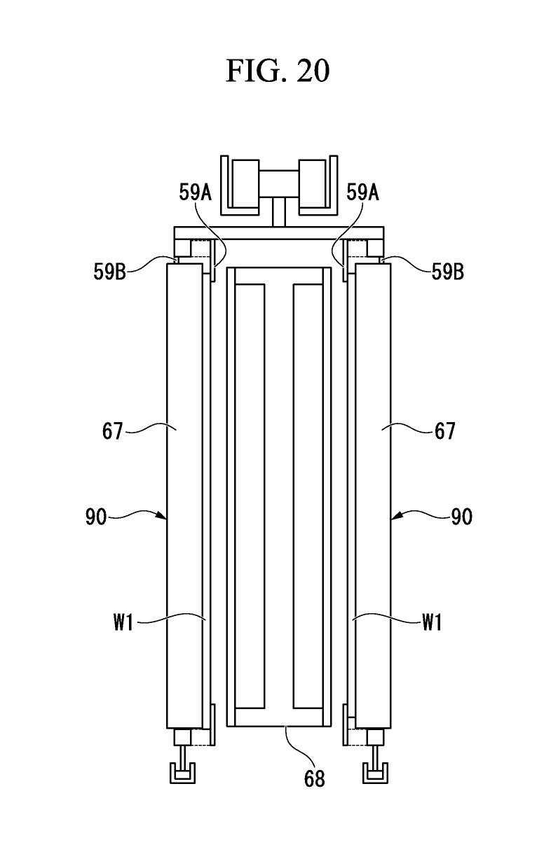

As shown in FIGS. 18 and 19, the two anode units 90 of the electrode unit 31 are moved by the drive unit 71 in the direction in which the anode units 90 approach each other, and the anode units 90 (anodes 67) and the rear surfaces WU of the substrates W1 before film forming processing come into contact with each other.

If the drive unit 71 is further driven as shown in FIG. 20, the substrates W1 before film forming processing move toward the cathode unit 68 so as to be pushed by the anodes 67. Then, the movement is made until the gap between the substrates W1 before film forming processing and the shower plates 75 of the cathode unit 68 becomes a predetermined distance (film forming distance). In addition, the gap (film forming distance) between the substrates W1 before film forming processing and the shower plates 75 of the cathode unit 68 is from 5 to 15 mm, or about 5 mm for example.

At this time, the pinching pieces 59A of the pinching portions 59 of the carrier 21 that comes into contact with the front surfaces WO side of the substrates W1 before film forming processing are displaced with the movement of the substrates W1 (anode units 90) before film forming processing. In addition, when the anode units 90 move toward the direction in which the anode units 90 separate from the cathode unit 68, the restoring forces of springs or the like act on the pinching pieces 59A, which are displaced toward the pinching pieces 59B. At this time, the substrates W1 before film forming processing are pinched by the anodes 67 and the pinching pieces 59A.

If the substrates W1 before film forming processing move toward the cathode unit 68, the pinching pieces 59A comes into contact with the masks 78, and the movement of the anode units 90 stops at this time (refer to FIG. 21).

Here, as shown in FIG. 21, the masks 78 are formed so as to cover the front surfaces of the pinching pieces 59A and the outer edge portions of the substrates W and are formed so as to be able to come into close contact with the outer edge portions of the pinching pieces 59A or the substrates W. That is, the mating surfaces between the masks 78 and the outer edge portions of the pinching pieces 59A or the substrates W have a role of sealing surfaces, and the film forming gas scarcely leaks from between the masks 78 and the outer edge portions of the pinching pieces 59A or the substrate W to the anodes 67.

Thereby, the range where the film forming gas spreads can be limited, and the film forming on unnecessary area is prevented. Thereby, a cleaning range can be reduced, cleaning frequency can be reduced, and the operating rate of the apparatus is improved.

Since the movement of the substrates W1 before film forming processing stops as the outer edge portions of the substrates W comes into contact with the masks 78, the gap between the masks 78 and the shower plate 75 and the gap between the masks and the evacuation duct 79, that is, the route height of the gas flow routes R in the thickness direction is set so that the gap between the substrates W1 before film forming processing and the cathode unit 68 becomes a predetermined distance.

As another embodiment, the distance between the substrates W and the shower plates 75 (=cathodes) can also be arbitrarily changed depending on the stroke of the drive unit 71 by attaching the masks to the evacuation duct 79 through elastic bodies. Although a case where the masks 78 and the substrates W come into contact with each other has been described above, the masks 78 and the substrates W may be arranged with a very small gap that limits the passage of the film forming gas.

By jetting the film forming gas from the shower plates 75 of the cathode unit 68 in the state, by starting the matching box 72, and by applying a voltage to the shower plates (=cathodes) 75 of the cathode unit 68, plasma is generated in the film-forming space 81, and the film forming is performed on the front surfaces WO of the substrates W1 before film forming processing. At this time, the substrates W1 before film forming processing are heated to a desired temperature by the heaters H built in the anodes 67.

Here, the anode units 90 stop heating if the substrates W1 before film forming processing reach the desired temperature. However, the plasma is generated in the film-forming spaces 81 by applying the voltage to the cathode unit 68. Even if the anode units 90 stops heating due to the input of heat from the plasma with the passing of time, there is a concern that the temperature of the substrates W1 before film forming processing may rise higher than the desired temperature.

In the case, the anode units 90 can also function as radiator plates for cooling the substrates W1 before film forming processing of which the temperature rises excessively. Accordingly, the substrates W1 before film forming processing are held at the desired temperature in spite of the passing of film forming processing time.

In addition, by switching a film forming gas material to be supplied in accordance with a predetermined time, it is possible to form a plurality of layers by a single film forming processing process.

During the film forming and after the film forming, the gas or particles in the film-forming spaces 81 formed in the peripheral edge portion of the cathode unit 68 are evacuated from the evacuation ports 80. The evacuated gas is passed from the evacuation duct 79 of the peripheral edge portion of the cathode unit 68 via the gas flow routes R through the opening portion (opening portion formed in the surface 82 of the evacuation duct 79 directed to the inside of the film-forming chamber 11 in the lower portion of the cathode unit 68) and evacuated to the outside from the evacuation pipe 29 provided in the side surface lower portion 28 of the film-forming chamber 11. Since the same processing as the above-described processing is performed in all the electrode units 31 in the film-forming chamber 11, the film forming can be simultaneously performed on the six substrates W.

Then, when the film formation is ended, the two anode units 90 will be moved by the drive unit 71 in the direction in which the anode units 90 separate from each other, and the substrates W2 after film forming processing and the frames 51 (pinching pieces 59A) are returned to their original positions (refer to FIGS. 19 and 21). Moreover, by moving the anode units 90 in the separating direction, the substrates W2 after film forming processing and the anode units 90 separate from each other (refer to FIG. 18).

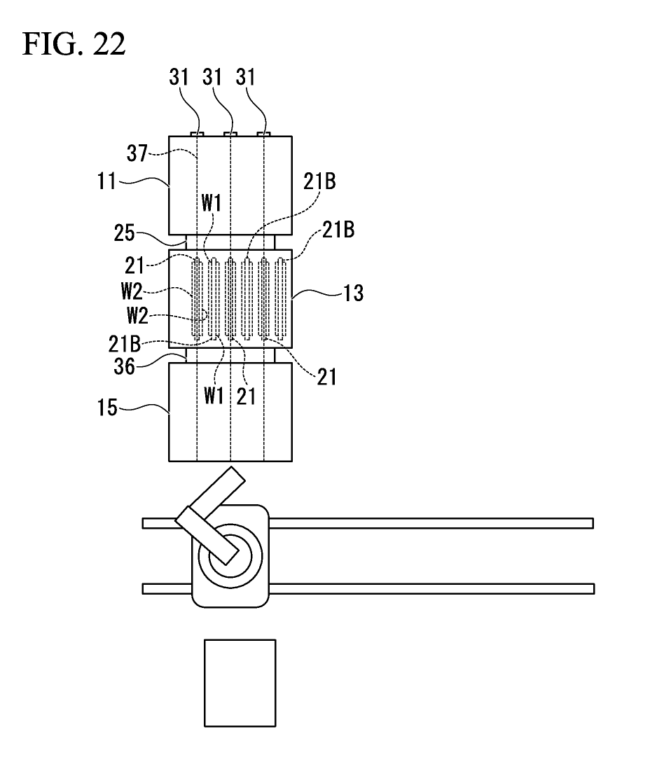

As shown in FIG. 22, the shutters 25 of the film-forming chamber 11 are brought into an open state, and the carriers 21 are moved to the loading and unloading chamber 13 by using the push-pull mechanism 38. The loading and unloading chamber 13 evacuates at this time, and the carriers 21B to which the substrates W1 before film forming processing on which the film forming is to be performed next are already located. Then, in the loading and unloading chamber 13, the heat accumulated in the substrates W2 after film forming processing is transferred to the substrate W1 before film forming processing, and the temperature of the substrates W2 after film forming processing is lowered.

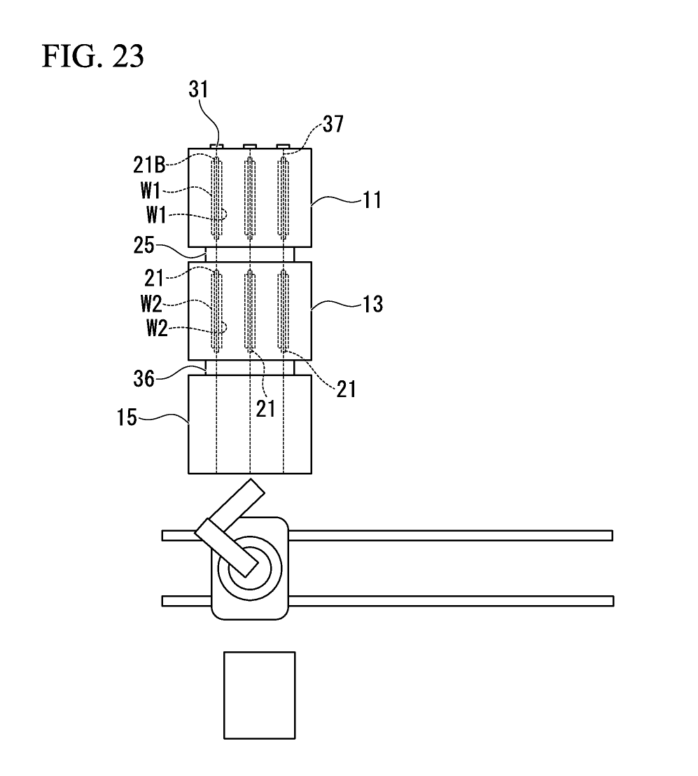

As shown in FIG. 23, after the carriers 21B move into the film-forming chamber 11, the carriers 21 are returned to the positions where the carriers are to be arranged on the movement rails 37 by the moving mechanism.

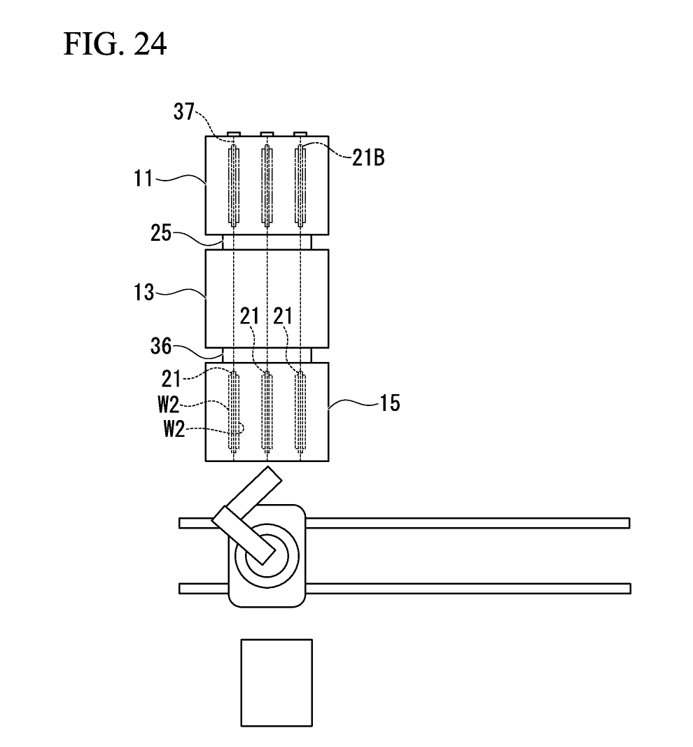

As shown in FIG. 24, after the shutters 25 are brought into a closed state and the temperature of the substrate W2 after film forming processing has dropped to a predetermined temperature, the shutters 36 are brought into an open state and the carriers 21 are moved to the substrate attachment and detachment chamber 15.

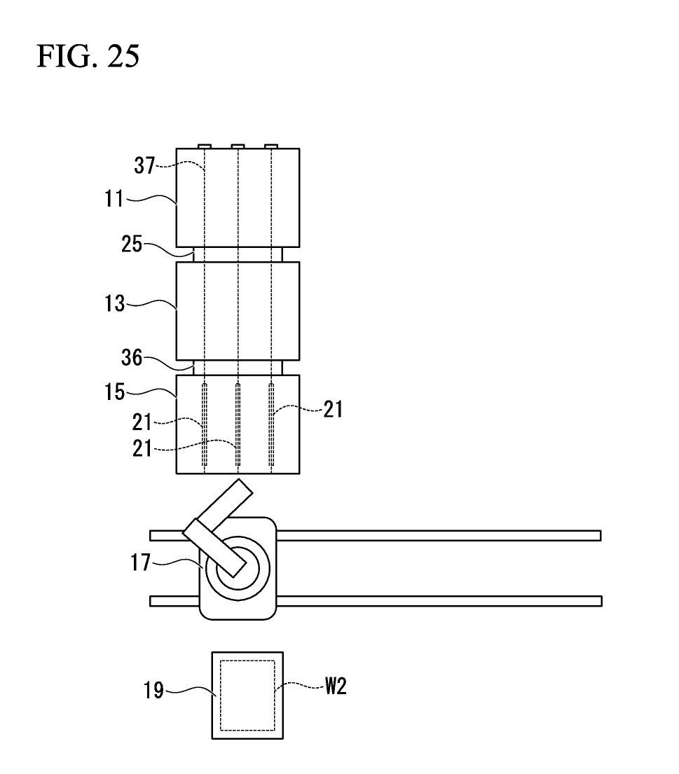

As shown in FIG. 25, in the substrate attachment and detachment chamber 15, the substrates W2 after film forming processing are detached from the carriers 21 by the substrate attachment and detachment robot 17 and are transferred to the substrate accommodating cassette 19. After the detachment of all the substrates W2 after film forming processing is completed, the substrate accommodating cassette 19 is moved to a place for the following process, and then the processing is ended.

Since the substrates W2 after film forming processing and the substrates W1 before film forming processing can be simultaneously accommodated in the loading and unloading chamber 13, an evacuation process can be omitted in a series of the substrate film forming processes of the loading and unloading chamber 13. Accordingly, the productivity can be improved.

If the substrates W2 after film forming processing and the substrates W1 before film forming processing are simultaneously accommodated in the loading and unloading chamber 13, the heat accumulated in the substrates W2 after film forming processing is transferred to the substrates W1 before film forming processing. In other words, the heat exchange is performed.

That is, a heating process that is usually performed after the substrates W1 before film forming processing are accommodated in the film-forming chamber 11 and a cooling process that is usually performed before the substrates W2 after film forming processing is taken out from the loading and unloading chamber 13 can be omitted. As a result, since the productivity can be improved and the facilities used for the conventional heating process and the conventional cooling process can be omitted, the manufacturing costs can be reduced.

In addition, the technical scope of the present invention is not limited to the above-described embodiment, but that various modifications of the above-described embodiment may be made without departing from the aspect of the invention. That is, the specific shapes and configurations mentioned in the embodiment are merely examples and can be appropriately changed.

(Method 1 for Maintaining the Film-Forming Apparatus)

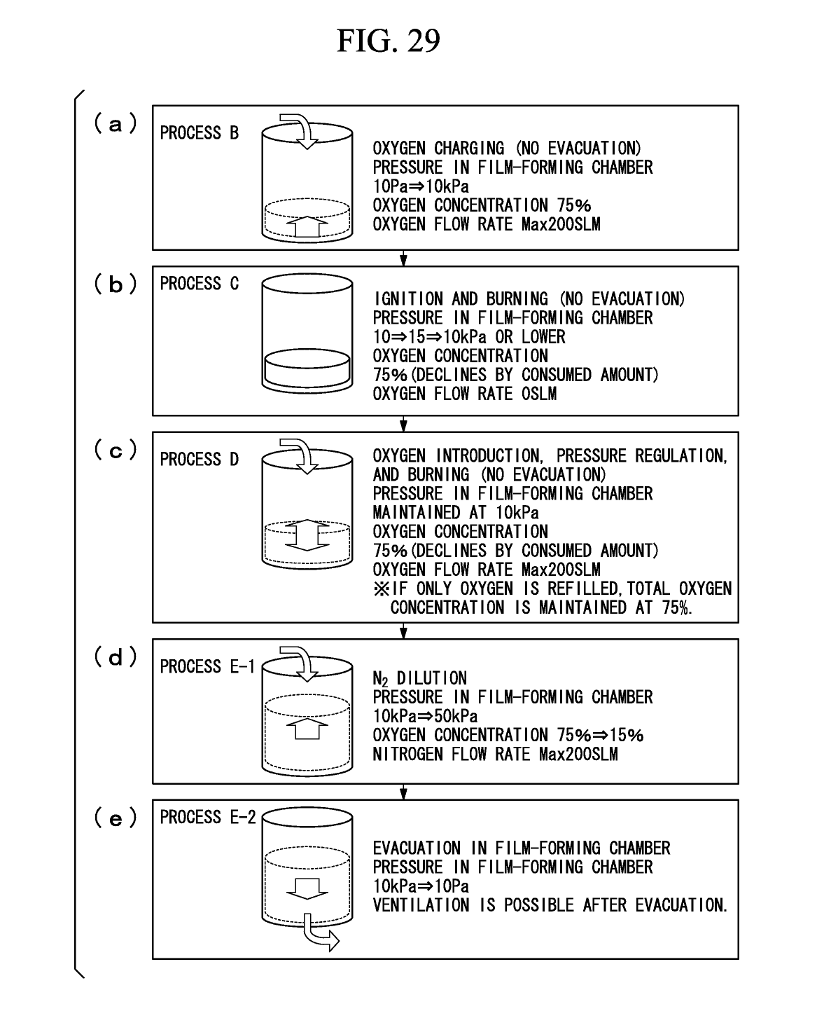

A method for maintaining the film-forming apparatus according to an embodiment of the invention will be described with reference to FIGS. 3A to 3C, 4A to 4D, and 29. FIG. 29 is an explanatory view showing the method for maintaining the film-forming apparatus of the invention in stages. In FIG. 29, a cylinder schematically represents the film-forming chamber 11.

When a film of microcrystalline silicon is formed on substrates W by using the film-forming apparatus according to the embodiment of the invention, a flammable by-product containing polysilane that is a dark brown powder (brown powder) is formed in the film-forming chamber 11. If the film forming continues in the state where the by-product is piled up in the film-forming chamber 11, the characteristics of the formed film deteriorate. For this reason, for example, the removal of the by-products as shown below is performed whenever the film forming of 50 to 300 times is performed on substrates W.

For example, after the film forming processes of about 300 times are completed, the shutters 25 of the film-forming chamber 11 are brought into an open state, and the carriers 21 are moved to the loading and unloading chamber 13 by using the push-pull mechanism 38 (refer to FIGS. 5A and 5B). Thereby, the substrates W (substrates W2 after film forming processing) on which the film is formed are conveyed out of the film-forming chamber 11 from the inside of the film-forming chamber 11 (Process A).

The substrate W is taken out from the film-forming chamber 11, the shutters 25 are brought into a closed state, and the evacuation pipe 29 is closed to close an evacuation system. Thereafter, oxygen is introduced into the film-forming chamber 11 through the shower plates 75 of the cathode unit 68 from the oxygen gas charging section (first gas charging section) 160 (FIG. 29(a), [Process B]).

The oxygen gas into the film-forming chamber 11 may be introduced so that the oxygen concentration in the film-forming chamber 11 becomes, for example, about 75%. Thereby, the internal pressure in the film-forming chamber 11 is raised to about 10 kPa from about 10 Pa. The oxygen gas can be introduced from the oxygen gas charging section (first gas charging section) 160 so that the oxygen concentration in the film-forming chamber 11 becomes about 75%, and the nitrogen gas can be introduced from the nitrogen gas charging section (second gas charging section) 150.

Next, a flowing current is applied to the ignition sections 39 formed at the bottom surface of the film-forming chamber 11. The by-product composed mainly of the polysilane formed by the film forming of the microcrystalline silicon of 50 to 300 times is piled up on the lower portion of the film-forming chamber 11. When the flowing current is applied to the ignition sections 39, burning caused by an oxidation reaction between the polysilane that is the flammable by-product and the oxygen gas introduced into the film-forming chamber 11 is started (FIG. 29(b), [Process C]).

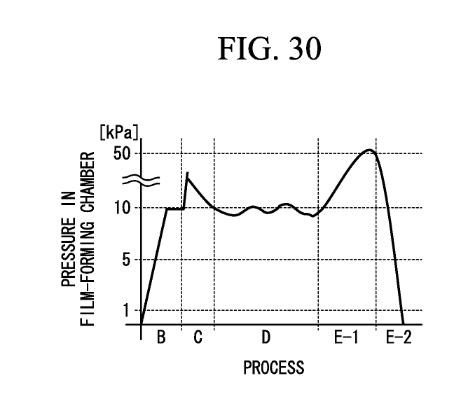

The temperature rises temporarily when the burning starts, and the internal pressure rises (Process C shown in FIG. 30). The temperature rise can be detected by the pressure gauge (first detecting section) 91 and the upper thermometer (third temperature detecting section) 93. The pressure and the amount of the oxygen in the film-forming chamber 11 before the ignition is preferably determined so that the pressure at the time of the ignition does not exceed an atmospheric pressure. The pressure decreases with consumption of the oxygen after the ignition.

Even during the burning of the by-product, the oxygen gas continues to be supplied into the film-forming chamber 11 from the oxygen gas charging section 160 and the burning of the by-product is made to continue (FIG. 29(c), [Process D]). The supplied amount of the oxygen gas is controlled to be a flow rate to approximately compensate for the reduction of the oxygen gas caused by the oxidation reaction (caused by a burning reaction) of the polysilane. Thereby, the internal pressure in the film-forming chamber 11 is approximately kept constant. For example, by continuing to flow the oxygen up to about 200 SLM, the internal pressure in the film-forming chamber 11 is maintained at 10 kPa, and the oxygen concentration is maintained at about 75%. In this Process D, the oxygen gas may be introduced from the oxygen gas charging section (first gas charging section) 160 in order to compensate for the consumption of the oxygen and to keep the internal pressure constant, and the nitrogen gas may not be introduced from the nitrogen gas charging section (second gas charging section) 150.

During the burning of the by-product, the pressure in the film-forming chamber 11 may be constantly monitored by the pressure gauge (first detecting section) 91 formed at the side surface of the film-forming chamber 11, and the flow rate of the oxygen gas from the oxygen gas charging section 160 may be controlled on the basis of the output of the pressure gauge 91 so that the inside of the film-forming chamber 11 is maintained at a predetermined internal pressure (for example, 10 kPa).

Additionally, during the burning of the by-product, the temperature of the by-product under burning is monitored by the lower thermometer (second detecting section) 92 formed at the side surface lower portion of the film-forming chamber 11. Additionally, the spatial temperature in the film-forming chamber 11 is monitored by the upper thermometer (third detecting section) 93 formed at the upper portion of the film-forming chamber 11. In a case where the temperature output data of the lower thermometer 92 and an upper thermometer 93 formed in the film-forming chamber 11 exceeds predetermined values, respectively, the burning is judged to be abnormal, and the burning of the by-product may be stopped by stop of the supply of the oxygen gas from the oxygen gas charging section 160.

By the burning of the by-product in the film-forming chamber 11 through this process D, in the film-forming chamber 11, the polysilane burns (oxidizes) by the oxygen and non-flammable silicon oxide (burning product) is formed. The burning product is piled up in the film-forming chamber 11.

After the burning of the by-product piled up in the film-forming chamber 11 is completed, the nitrogen gas is now introduced into the film-forming chamber 11 from the nitrogen gas charging section (second gas charging section) 150 with closing the evacuation system (FIG. 29(d), [Process E-1]). Thereby, the concentration of the oxygen in the film-forming chamber 11 is diluted. The nitrogen gas may be introduced at a maximum flow rate of, for example, 200 SLM or less until the oxygen concentration in the film-forming chamber 11 declines to, for example, about 15%. Thereby, the internal pressure in the film-forming chamber 11 rises to, for example, about 50 kPa.

The completion of the burning of the by-product can be detected by the monitoring of the temperature of the lower thermometer (second detecting section) 92 or the reduction/termination of the introduced amount of the oxygen and can also be regarded as the completion with the passing of a predetermined constant time.

Thereafter, a valve (not shown) of the evacuation pipe 29 is opened, the vacuum pump 30 is operated to evacuate a mixed gas of the nitrogen and the oxygen in the film-forming chamber 11 from the evacuation pipe 29 (FIG. 29(e), [Process E-2]). At this time, since the oxygen concentration in the film-forming chamber 11 is diluted with the nitrogen gas (oxygen concentration of about 15%) in Process E-1, the gas in the film-forming chamber 11 can be safely evacuated.

Then, after the inside of the film-forming chamber 11 is set to ordinary pressure, the silicon oxide (burning product) piled up at the bottom of the film-forming chamber 11 is suctioned and removed by using, for example, a vacuum cleaner or the like. When the deposit is removed, since the flammable by-product (polysilane) piled up in the film-forming chamber 11 is changed to the non-flammable burning product (silicon oxide) by Process B to Process C, there is no concern that the deposit may be ignited during suction and removal. The burning product in the film-forming chamber 11 can be safely collected and removed. Moreover, since the collected burning product is also non-flammable, it is possible to perform keeping or processing safely.

The pressure changes in the film-forming chamber 11 in the processes of FIG. 29 are shown by using a graph in FIG. 30.

In the embodiment, the control is made so that the pressure in the film-forming chamber 11 is kept constant from Process C in which the by-product is ignited by the ignition sections 39 to Process D in which the oxygen gas continues to be supplied into the film-forming chamber 11 from the oxygen gas charging section 160 so as to keep the burning of the by-product.

According to the graph of FIG. 30, the internal pressure in the film-forming chamber 11 rises from about 10 Pa to about 10 kPa by charging the oxygen in Process B. Then, when the by-product is ignited in Process C, the internal pressure of the film-forming chamber 11 rises to about 15 kPa in an instant, but the internal pressure becomes about 10 kPa immediately. Then, the film-forming chamber 11 is maintained at the internal pressure of about 10 kPa by charging the same amount of oxygen as the oxygen consumed by the burning in the film-forming chamber 11 in Process D. Thereafter, when the nitrogen for the dilution is introduced into the film-forming chamber 11 in Process E-1, the internal pressure of the film-forming chamber 11 rises to about 50 kPa, and when the inside of the film-forming chamber 11 is evacuated in Process E-2, the internal pressure drops promptly to 1 kPa or lower.

(Method 2 for Maintaining the Film-Forming Apparatus)

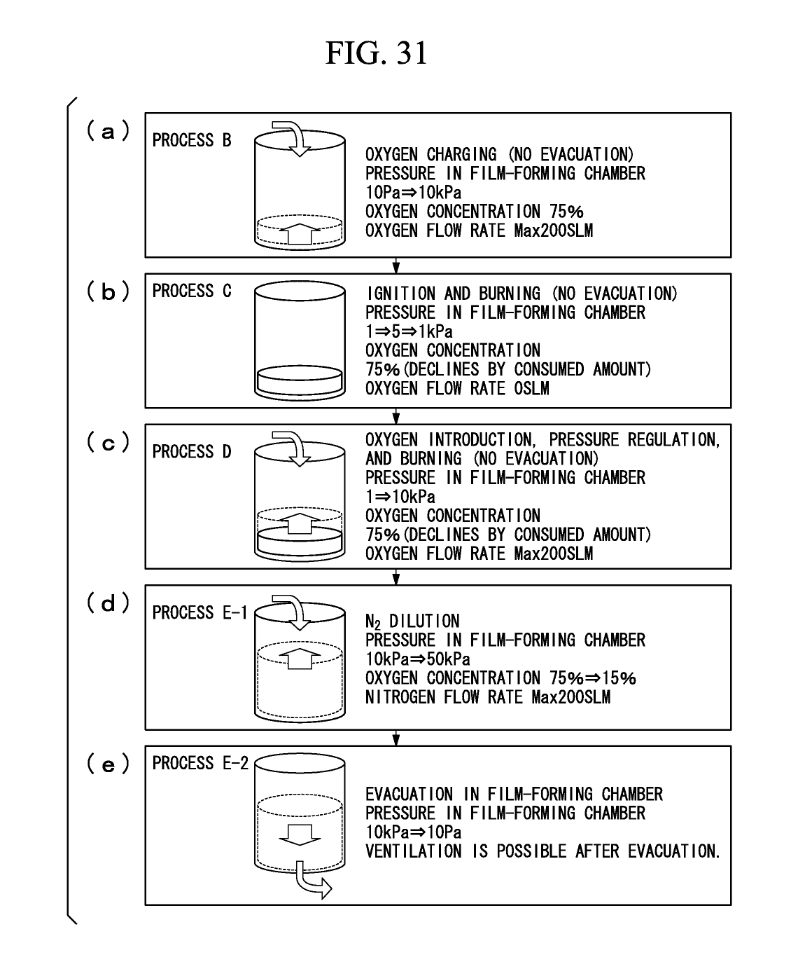

Another method for maintaining the film-forming apparatus of the invention will be described with reference to FIGS. 3A to 3C, 4A to 4D, and 31. FIG. 31 is an explanatory view showing another method for maintaining the film-forming apparatus of the invention in stages.

In the maintenance method of the embodiment, the substrates W (substrates W2 after film forming processing) on which the film is formed are conveyed out of the film-forming chamber 11 from the inside of the film-forming chamber 11 (Process A). Then, the shutters 25 are brought into a closed state, and the evacuation pipe 29 is closed to close the evacuation system. Thereafter, the oxygen is introduced into the film-forming chamber 11 through the shower plates 75 of the cathode unit 68 from the oxygen gas charging section (first gas charging section) 160 (FIG. 31(a), [Process B]).

The oxygen gas may be introduced into the film-forming chamber 11 so that the oxygen concentration in the film-forming chamber 11 becomes, for example, about 75%. Thereby, the internal pressure in the film-forming chamber 11 is raised to about 1 kPa from about 10 Pa. The oxygen gas can be introduced from the oxygen gas charging section (first gas charging section) 160 so that the oxygen concentration in the film-forming chamber 11 becomes about 75%, and the nitrogen gas can be introduced from the nitrogen gas charging section (second gas charging section) 150.

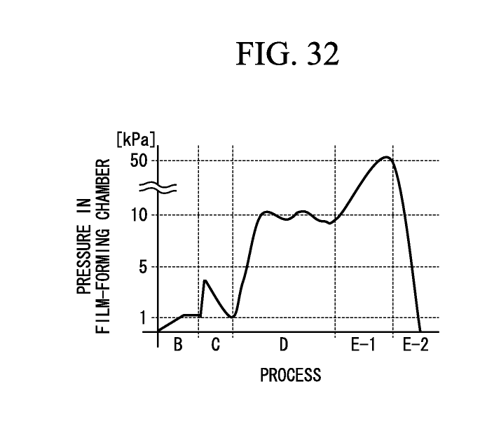

Next, the flowing current is applied to the ignition sections 39 in a low-pressure state wherein the internal pressure of the film-forming chamber 11 is as low as, for example, about 1 kPa. Thereby, burning caused by an oxidation reaction between the polysilane that is the flammable by-product, and the oxygen gas introduced into the film-forming chamber 11 is started (FIG. 31(b), [Process C]). The temperature rises temporarily when the burning starts, and the internal pressure rises (Process C of FIG. 32). The temperature rise can be detected by the pressure gauge (first detecting section) 91 and the upper thermometer (third temperature detecting section) 93. In the embodiment, since the pressure and the amount of the oxygen in the film-forming chamber 11 before the ignition are sufficiently low, the temporary pressure rise is also small. The pressure decreases with consumption of the oxygen after the ignition.

Then, after the start of the burning, the oxygen gas and the nitrogen gas is supplied so that the internal pressure in the film-forming chamber 11 becomes a high pressure of about 10 kPa. When Process D starts, the oxygen gas is introduced from the oxygen gas charging section (first gas charging section) 160 so that the oxygen concentration in the film-forming chamber 11 becomes about 75%, and the nitrogen gas is introduced from the nitrogen gas charging section (second gas charging section) 150. When the internal pressure becomes about 10 kPa, the amount of the oxygen consumed by the burning is introduced so that the pressure is kept constant.

Thereby, the burning of the by-product is made to continue (FIG. 31(c), [Process D]). The supplied amount of the oxygen gas is controlled to be a flow rate to approximately compensate for the reduction of the oxygen gas caused by the oxidation reaction (caused by a burning reaction) of the polysilane. Thereby, the internal pressure in the film-forming chamber 11 is approximately kept constant. For example, by continuing to flow the oxygen up to about 200 SLM, the internal pressure in the film-forming chamber 11 is maintained at 10 kPa, and the oxygen concentration is maintained at about 75%.

During the burning of the by-product, the pressure in the film-forming chamber 11 may be constantly monitored by the pressure gauge (first detecting section) 91 formed at the side surface of the film-forming chamber 11, and the flow rate of the oxygen gas from the oxygen gas charging section 160 may be controlled on the basis of the output of the pressure gauge 91 so that the inside of the film-forming chamber 11 is maintained at a predetermined internal pressure (for example, 10 kPa).

By the burning of the by-product in the film-forming chamber 11 through this Process D, in the film-forming chamber 11, the polysilane burns (oxidizes) by oxygen and non-flammable silicon oxide (burning product) is formed. The burning product is piled up in the film-forming chamber 11.

Thereafter, when the burning of the by-product piled up in the film-forming chamber 11 is completed, the nitrogen gas is introduced into the film-forming chamber 11 from the nitrogen gas charging section (second gas charging section) 150 (FIG. 31(d), [Process E-1]), and the concentration in the film-forming chamber 11 is diluted.

The nitrogen gas may be introduced at a maximum flow rate of, for example, 200 SLM or less until the oxygen concentration in the film-forming chamber 11 declines to, for example, about 15%. Thereby, the internal pressure in the film-forming chamber 11 rises to, for example, about 50 kPa.

The completion of the burning of the by-product can be detected by the monitoring of the temperature of the lower thermometer (second detecting section) 92 or the reduction/termination of the introduced amount of the oxygen, and can also be regarded as the complete with the passing of a predetermined constant time.

Thereafter, a valve (not shown) of the evacuation pipe 29 is opened, the vacuum pump 30 is operated to evacuate a mixed gas of the nitrogen and the oxygen in the film-forming chamber 11 from the evacuation pipe 29 (FIG. 31(e), [Process E-2]). Then, after the inside of the film-forming chamber 11 is set to the ordinary pressure, the silicon oxide (burning product) piled up at the bottom of the film-forming chamber 11 is suctioned and removed by using, for example, a vacuum cleaner or the like.

The pressure changes in the film-forming chamber 11 in the processes of FIG. 31 are shown by using a graph in FIG. 32.

In the embodiment, the control is made so that the pressure just before the ignition in Process C in which the by-product is ignited by the ignition sections 39 is made lower than the internal pressure in the film-forming chamber 11 in Process D in which the oxygen gas continues to be supplied into the film-forming chamber 11 from the oxygen gas charging section 160 so as to keep the burning of the by-product (two-stage burning).

According to the graph of FIG. 32, the internal pressure in the film-forming chamber 11 rises from about 10 Pa to about 1 kPa by charging the oxygen in Process B. Then, when the by-product is ignited in Process C, the internal pressure of the film-forming chamber 11 rises to about 4 kPa in an instant, but the internal pressure becomes about 1 kPa immediately.

Then, the internal pressure of the film-forming chamber 11 is raised to about 10 kPa when the same amount of oxygen as the oxygen consumed by the burning is introduced into the film-forming chamber 11 in Process D. In Process D, the internal pressure of the film-forming chamber 11 is maintained at about 10 kPa, and the burning of the by-product is performed. Thereafter, when the nitrogen for the dilution is introduced into the film-forming chamber 11 in Process E-1, the internal pressure of the film-forming chamber 11 rises to about 50 kPa, and when the inside of the film-forming chamber 11 is evacuated in Process E-2, the internal pressure drops promptly to 1 kPa or lower.

The pressure rise at the time of the ignition can be restricted by making the pressure before the ignition low, and the burning rate can be further raised by making the pressure during the burning high. In addition, even if the pressure rises immediately after the ignition, it is preferable to control the pressure to be lower than an atmospheric pressure. This is because the film-forming chamber 11 is prepared for a decompression.

### EXAMPLES

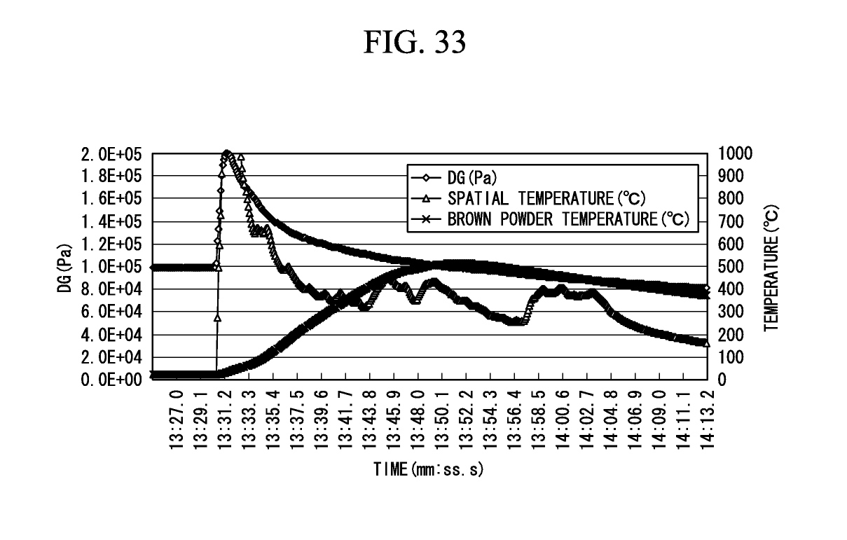

The temperature (brown powder temperature) of the by-product, the spatial temperature in the film-forming chamber 11, and the internal pressure (DG) in the film-forming chamber 11 before the by-product (polysilane) is ignited and during the by-product is burned were measured by using the film-forming chamber 11 as shown in FIGS. 5A and 5B. The measurement results are shown in FIG. 33. In addition, the temperature of the by-product was measured by the lower thermometer (second detecting section) 92 (refer to FIGS. 3A to 3C) formed at the side surface lower surface of the film-forming chamber 11, and the spatial temperature in the film-forming chamber 11 was measured by the upper thermometer (third temperature detecting section) 93 (refer to FIGS. 3A to 3C) formed at the upper portion of the film-forming chamber 11. Additionally, the internal pressure (DG) in the film-forming chamber 11 was measured by the pressure gauge (first detecting section) 91 formed at the side surface of the film-forming chamber 11.

As shown in the graph of FIG. 33, the temperature (brown powder temperature) of the by-product rises gently with a decrease in the internal pressure (DG) in the film-forming chamber 11 or the spatial temperature in the film-forming chamber 11 after the ignition to the by-product (brown powder). Thereafter, it was confirmed that it was possible to stably burn the by-product in a predetermined temperature (burning temperature) range.

### INDUSTRIAL APPLICABILITY

The invention can be widely applied to a film-forming apparatus that forms a silicon film on a substrate by using the CVD method.

### REFERENCE SIGNS LIST

10: FILM-FORMING APPARATUS
11: FILM-FORMING CHAMBER
13: LOADING AND UNLOADING CHAMBER
14: PROCESS MODULE
15: SUBSTRATE ATTACHMENT AND DETACHMENT CHAMBER
17: SUBSTRATE ATTACHMENT AND DETACHMENT ROBOT (DRIVING MECHANISM)
19: SUBSTRATE ACCOMMODATING CASSETTE (CONVEYING PART)
21: CARRIER (FIRST CARRIER, SECOND CARRIER)
25: SHUTTER (FIRST OPENING AND CLOSING PART)
36: SHUTTER (SECOND OPENING AND CLOSING PART)
104: BOTTOM CELL (DESIRED FILM)
W: SUBSTRATE
W1: SUBSTRATE BEFORE FILM FORMING PROCESSING
W2: SUBSTRATE AFTER FILM FORMING PROCESSING
150: NITROGEN GAS CHARGING SECTION (SECOND GAS CHARGING SECTION)
160: OXYGEN GAS CHARGING SECTION (FIRST GAS CHARGING SECTION)

What is claimed is:

1. A film-forming apparatus comprising:
a film-forming chamber in which a film is formed on a substrate under reduced pressure;
an ignition section that ignites a flammable by-product formed in the film-forming chamber;
a first gas charging section that supplies an oxygen gas to the film-forming chamber;
a second gas charging section that supplies a nitrogen gas to the film-forming chamber; and
a first detecting section that measures a pressure in the film-forming chamber.

2. The film-forming apparatus according to claim 1, wherein the film-forming chamber is provided with a second detecting section that measures a temperature of the by-product.

3. The film-forming apparatus according to claim 1, wherein the film-forming chamber is provided with a third temperature detecting section that measures a spatial temperature in the film-forming chamber.

4. A method for maintaining a film-forming apparatus that forms a film on a substrate under reduced pressure, the method comprising:
conveying the substrate having the film formed thereon from an inside of a film-forming chamber of the film-forming apparatus to an outside of the film-forming chamber;
charging an oxygen gas into the film-forming chamber;
igniting a flammable by-product formed by film forming;
burning the by-product;
charging a nitrogen gas into the film-forming chamber; and
removing a non-flammable oxidized by-product formed when the by-product is burned from the film-forming chamber.

5. The method for maintaining the film-forming apparatus according to claim 4, wherein when the by-product is burned, the oxygen gas is supplied to the film-forming chamber in order to control a pressure in the film-forming chamber to be constant in substance.

6. The method for maintaining the film-forming apparatus according to claim 4, wherein, when the by-product is burned, an evacuation system of the film-forming chamber is closed.

7. The method for maintaining the film-forming apparatus according to claim 4, wherein when the flammable by-product is ignited and when the by-product is burned, a pressure control is performed in order to control a pressure in the film-forming chamber to be constant in substance.

8. The method for maintaining the film-forming apparatus according to claim 4, wherein when the flammable by-product is ignited, pressure control is performed in order to control a pressure in the film-forming chamber to be lower than that when the by-product is burned.

9. The method for maintaining the film-forming apparatus according to claim 4, wherein an evacuation gas evacuated from the film-forming chamber is diluted with the nitrogen gas.

10. The method for maintaining the film-forming apparatus according to claim 6, wherein when the flammable by-product is ignited and when the by-product is burned, a pressure control is performed in order to control a pressure in the film-forming chamber to be constant in substance.

11. The method for maintaining the film-forming apparatus according to claim 6, wherein when the flammable by-product is ignited, pressure control is performed in order to control a pressure in the film-forming chamber to be lower than that when the by-product is burned.

12. The method for maintaining the film-forming apparatus according to claim 6, wherein an evacuation gas evacuated from the film-forming chamber is diluted with the nitrogen gas.

13. The method for maintaining the film-forming apparatus according to claim 7, wherein an evacuation gas evacuated from the film-forming chamber is diluted with the nitrogen gas.

14. The method for maintaining the film-forming apparatus according to claim 8, wherein an evacuation gas evacuated from the film-forming chamber is diluted with the nitrogen gas.

15. The method for maintaining the film-forming apparatus according to claim 10, wherein an evacuation gas evacuated from the film-forming chamber is diluted with the nitrogen gas.

16. The method for maintaining the film-forming apparatus according to claim 11, wherein an evacuation gas evacuated from the film-forming chamber is diluted with the nitrogen gas.
